(19) United States
(12) Patent Application Publication
(10) Pub. No.: US 2025/0110634 A1
(43) Pub. Date: Apr. 3, 2025

(54) TECHNIQUES FOR PROVIDING CONTROLS

(71) Applicant: Apple Inc., Cupertino, CA (US)

(72) Inventors: Arian BEHZADI, San Francisco, CA (US); Christopher P. FOSS, San Francisco, CA (US); Andrew S. KIM, Walnut Creek, CA (US); David A. KRIMSLEY, Sunnyvale, CA (US); Christopher D. MATTHEWS, San Francisco, CA (US); Corey K. WANG, Palo Alto, CA (US)

(21) Appl. No.: 18/896,574

(22) Filed: Sep. 25, 2024

Related U.S. Application Data
(60) Provisional application No. 63/541,818, filed on Sep. 30, 2023.
(60) Provisional application No. 63/541,808, filed on Sep. 30, 2023.

(51) Int. Cl. G06F 3/04847

(52) U.S. Cl. CPC G06F 3/04847

(57) ABSTRACT

The present disclosure generally relates to providing controls.

### CROSS-REFERENCE TO RELATED APPLICATIONS

This application claims priority to U.S. Provisional Patent Application Ser. No. 63/541,818 entitled “TECHNIQUES FOR PROVIDING CONTROLS,” filed Sep. 30, 2023, and to U.S. Provisional Patent Application Ser. No. 63/541,808 entitled “USER INTERFACES FOR DISPLAYING CONTROLS,” filed Sep. 30, 2023, which are incorporated by reference herein in their entireties for all purposes.

### FIELD

The present disclosure relates generally to computer user interfaces, and more specifically to techniques for providing controls.

### BACKGROUND

Electronic devices often provide controls. Such controls are used to perform operations.

### SUMMARY

Some techniques for providing controls using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for providing controls. Such methods and interfaces optionally complement or replace other methods for providing controls. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a display component is described. In some embodiments, the method comprises: detecting a change to a coupling status of the computer system; and in response to detecting the change to the coupling status of the computer system: in accordance with a determination that a first set of one or more criteria is met, wherein the first set of one or more criteria includes a criterion that is met when a determination is made that the computer system is currently magnetically coupled to a respective area, displaying, via the display component, a first user interface that includes a first set of one or more controls; and in accordance with a determination that a second set of one or more criteria is met, wherein the second set of one or more criteria includes a criterion that is met when a determination is made that the computer system is not currently magnetically coupled, displaying, via the display component, a second user interface that includes a second set of one or more controls, wherein the second set of one or more controls are different from the first set of one or more controls.

In some embodiments, a non-transitory computer-readable storage medium storing one or more programs configured to be executed by one or more processors of a computer system that is in communication with a display component is described. In some embodiments, the one or more programs includes instructions for: detecting a change to a coupling status of the computer system; and in response to detecting the change to the coupling status of the computer system: in accordance with a determination that a first set of one or more criteria is met, wherein the first set of one or more criteria includes a criterion that is met when a determination is made that the computer system is currently magnetically coupled to a respective area, displaying, via the display component, a first user interface that includes a first set of one or more controls; and in accordance with a determination that a second set of one or more criteria is met, wherein the second set of one or more criteria includes a criterion that is met when a determination is made that the computer system is not currently magnetically coupled, displaying, via the display component, a second user interface that includes a second set of one or more controls, wherein the second set of one or more controls are different from the first set of one or more controls.

In some embodiments, a transitory computer-readable storage medium storing one or more programs configured to be executed by one or more processors of a computer system that is in communication with a display component is described. In some embodiments, the one or more programs includes instructions for: detecting a change to a coupling status of the computer system; and in response to detecting the change to the coupling status of the computer system: in accordance with a determination that a first set of one or more criteria is met, wherein the first set of one or more criteria includes a criterion that is met when a determination is made that the computer system is currently magnetically coupled to a respective area, displaying, via the display component, a first user interface that includes a first set of one or more controls; and in accordance with a determination that a second set of one or more criteria is met, wherein the second set of one or more criteria includes a criterion that is met when a determination is made that the computer system is not currently magnetically coupled, displaying, via the display component, a second user interface that includes a second set of one or more controls, wherein the second set of one or more controls are different from the first set of one or more controls.

In some embodiments, a computer system that is in communication with a display component is described. In some embodiments, the computer system that is in communication with a display component comprises one or more processors and memory storing one or more programs configured to be executed by the one or more processors. In some embodiments, the one or more programs includes instructions for: detecting a change to a coupling status of the computer system; and in response to detecting the change to the coupling status of the computer system: in accordance with a determination that a first set of one or more criteria is met, wherein the first set of one or more criteria includes a criterion that is met when a determination is made that the computer system is currently magnetically coupled to a respective area, displaying, via the display component, a first user interface that includes a first set of one or more controls; and in accordance with a determination that a second set of one or more criteria is met, wherein the second set of one or more criteria includes a criterion that is met when a determination is made that the computer system is not currently magnetically coupled, displaying, via the display component, a second user interface that includes a second set of one or more controls, wherein the second set of one or more controls are different from the first set of one or more controls.

In some embodiments, a computer system that is in communication with a display component is described. In some embodiments, the computer system that is in communication with a display component comprises means for performing each of the following steps: detecting a change to a coupling status of the computer system; and in response to detecting the change to the coupling status of the computer system: in accordance with a determination that a first set of one or more criteria is met, wherein the first set of one or more criteria includes a criterion that is met when a determination is made that the computer system is currently magnetically coupled to a respective area, displaying, via the display component, a first user interface that includes a first set of one or more controls; and in accordance with a determination that a second set of one or more criteria is met, wherein the second set of one or more criteria includes a criterion that is met when a determination is made that the computer system is not currently magnetically coupled, displaying, via the display component, a second user interface that includes a second set of one or more controls, wherein the second set of one or more controls are different from the first set of one or more controls.

In some embodiments, a computer program product is described. In some embodiments, the computer program product comprises one or more programs configured to be executed by one or more processors of a computer system that is in communication with a display component. In some embodiments, the one or more programs include instructions for: detecting a change to a coupling status of the computer system; and in response to detecting the change to the coupling status of the computer system: in accordance with a determination that a first set of one or more criteria is met, wherein the first set of one or more criteria includes a criterion that is met when a determination is made that the computer system is currently magnetically coupled to a respective area, displaying, via the display component, a first user interface that includes a first set of one or more controls; and in accordance with a determination that a second set of one or more criteria is met, wherein the second set of one or more criteria includes a criterion that is met when a determination is made that the computer system is not currently magnetically coupled, displaying, via the display component, a second user interface that includes a second set of one or more controls, wherein the second set of one or more controls are different from the first set of one or more controls.

In some embodiments, a method that is performed at a computer system that is in communication with a display component is described. In some embodiments, the method comprises: displaying, via the display component, a first user interface that includes first content and a first plurality of selection indicators, the first plurality of selection indicators including a selection indicator that indicates that the first content is selected; while displaying, via the display component, the first user interface that includes the first content and the first plurality of selection indicators and the selection indicator that indicates that the first content is selected, detecting a change to a coupling status of the computer system; and in response to detecting the change to the coupling status of the computer system: ceasing display of the selection indicator that indicates that the first content is selected; and displaying, via the display component, a second user interface that includes second content and a second plurality of selection indicators, the second plurality of selection indicators including a selection indicator that indicates that the second content is selected, wherein the second content is different from the first content.

In some embodiments, a non-transitory computer-readable storage medium storing one or more programs configured to be executed by one or more processors of a computer system that is in communication with a display component is described. In some embodiments, the one or more programs includes instructions for: displaying, via the display component, a first user interface that includes first content and a first plurality of selection indicators, the first plurality of selection indicators including a selection indicator that indicates that the first content is selected; while displaying, via the display component, the first user interface that includes the first content and the first plurality of selection indicators and the selection indicator that indicates that the first content is selected, detecting a change to a coupling status of the computer system; and in response to detecting the change to the coupling status of the computer system: ceasing display of the selection indicator that indicates that the first content is selected; and displaying, via the display component, a second user interface that includes second content and a second plurality of selection indicators, the second plurality of selection indicators including a selection indicator that indicates that the second content is selected, wherein the second content is different from the first content.

In some embodiments, a transitory computer-readable storage medium storing one or more programs configured to be executed by one or more processors of a computer system that is in communication with a display component is described. In some embodiments, the one or more programs includes instructions for: displaying, via the display component, a first user interface that includes first content and a first plurality of selection indicators, the first plurality of selection indicators including a selection indicator that indicates that the first content is selected; while displaying, via the display component, the first user interface that includes the first content and the first plurality of selection indicators and the selection indicator that indicates that the first content is selected, detecting a change to a coupling status of the computer system; and in response to detecting the change to the coupling status of the computer system: ceasing display of the selection indicator that indicates that the first content is selected; and displaying, via the display component, a second user interface that includes second content and a second plurality of selection indicators, the second plurality of selection indicators including a selection indicator that indicates that the second content is selected, wherein the second content is different from the first content.

In some embodiments, a computer system that is in communication with a display component is described. In some embodiments, the computer system that is in communication with a display component comprises one or more processors and memory storing one or more programs configured to be executed by the one or more processors. In some embodiments, the one or more programs includes instructions for: displaying, via the display component, a first user interface that includes first content and a first plurality of selection indicators, the first plurality of selection indicators including a selection indicator that indicates that the first content is selected; while displaying, via the display component, the first user interface that includes the first content and the first plurality of selection indicators and the selection indicator that indicates that the first content is selected, detecting a change to a coupling status of the computer system; and in response to detecting the change to the coupling status of the computer system: ceasing display of the selection indicator that indicates that the first content is selected; and displaying, via the display component, a second user interface that includes second content and a second plurality of selection indicators, the second plurality of selection indicators including a selection indicator that indicates that the second content is selected, wherein the second content is different from the first content.

In some embodiments, a computer system that is in communication with a display component is described. In some embodiments, the computer system that is in communication with a display component comprises means for performing each of the following steps: displaying, via the display component, a first user interface that includes first content and a first plurality of selection indicators, the first plurality of selection indicators including a selection indicator that indicates that the first content is selected; while displaying, via the display component, the first user interface that includes the first content and the first plurality of selection indicators and the selection indicator that indicates that the first content is selected, detecting a change to a coupling status of the computer system; and in response to detecting the change to the coupling status of the computer system: ceasing display of the selection indicator that indicates that the first content is selected; and displaying, via the display component, a second user interface that includes second content and a second plurality of selection indicators, the second plurality of selection indicators including a selection indicator that indicates that the second content is selected, wherein the second content is different from the first content.

In some embodiments, a computer program product is described. In some embodiments, the computer program product comprises one or more programs configured to be executed by one or more processors of a computer system that is in communication with a display component. In some embodiments, the one or more programs include instructions for: displaying, via the display component, a first user interface that includes first content and a first plurality of selection indicators, the first plurality of selection indicators including a selection indicator that indicates that the first content is selected; while displaying, via the display component, the first user interface that includes the first content and the first plurality of selection indicators and the selection indicator that indicates that the first content is selected, detecting a change to a coupling status of the computer system; and in response to detecting the change to the coupling status of the computer system: ceasing display of the selection indicator that indicates that the first content is selected; and displaying, via the display component, a second user interface that includes second content and a second plurality of selection indicators, the second plurality of selection indicators including a selection indicator that indicates that the second content is selected, wherein the second content is different from the first content.

In some embodiments, a method that is performed at a computer system that is in communication with a display component, a first set of one or more devices that does not include an object, a second set of one or more devices that does not include the object, and one or more input devices is described. In some embodiments, the method comprises: detecting, via the one or more input devices, a request to identify a location of the object; and in response to detecting the request to identify the location of the object: in accordance with a determination that the first set of one or more devices meets a respective set of one or more criteria and the second set of one or more devices does not meet the respective set of one or more criteria, causing the first set of one or more devices to provide output indicating the position of the object in an environment without causing the second set of one or more devices to provide output indicating the position of the object in the environment; and in accordance with a determination that the first set of one or more devices does not meet the respective set of one or more criteria and the second set of one or more meets the respective set of one or more criteria, causing the second set of one or more devices to provide output indicating the position of the object in the environment without causing the first set of one or more devices to provide output indicating the position of the object in the environment.

In some embodiments, a non-transitory computer-readable storage medium storing one or more programs configured to be executed by one or more processors of a computer system that is in communication with a display component, a first set of one or more devices that does not include an object, a second set of one or more devices that does not include the object, and one or more input devices is described. In some embodiments, the one or more programs includes instructions for: detecting, via the one or more input devices, a request to identify a location of the object; and in response to detecting the request to identify the location of the object: in accordance with a determination that the first set of one or more devices meets a respective set of one or more criteria and the second set of one or more devices does not meet the respective set of one or more criteria, causing the first set of one or more devices to provide output indicating the position of the object in an environment without causing the second set of one or more devices to provide output indicating the position of the object in the environment; and in accordance with a determination that the first set of one or more devices does not meet the respective set of one or more criteria and the second set of one or more meets the respective set of one or more criteria, causing the second set of one or more devices to provide output indicating the position of the object in the environment without causing the first set of one or more devices to provide output indicating the position of the object in the environment.

In some embodiments, a transitory computer-readable storage medium storing one or more programs configured to be executed by one or more processors of a computer system that is in communication with a display component, a first set of one or more devices that does not include an object, a second set of one or more devices that does not include the object, and one or more input devices is described. In some embodiments, the one or more programs includes instructions for: detecting, via the one or more input devices, a request to identify a location of the object; and in response to detecting the request to identify the location of the object: in accordance with a determination that the first set of one or more devices meets a respective set of one or more criteria and the second set of one or more devices does not meet the respective set of one or more criteria, causing the first set of one or more devices to provide output indicating the position of the object in an environment without causing the second set of one or more devices to provide output indicating the position of the object in the environment; and in accordance with a determination that the first set of one or more devices does not meet the respective set of one or more criteria and the second set of one or more meets the respective set of one or more criteria, causing the second set of one or more devices to provide output indicating the position of the object in the environment without causing the first set of one or more devices to provide output indicating the position of the object in the environment.

In some embodiments, a computer system that is in communication with a display component, a first set of one or more devices that does not include an object, a second set of one or more devices that does not include the object, and one or more input devices is described. In some embodiments, the computer system that is in communication with a display component, a first set of one or more devices that does not include an object, a second set of one or more devices that does not include the object, and one or more input devices comprises one or more processors and memory storing one or more programs configured to be executed by the one or more processors. In some embodiments, the one or more programs includes instructions for: detecting, via the one or more input devices, a request to identify a location of the object; and in response to detecting the request to identify the location of the object: in accordance with a determination that the first set of one or more devices meets a respective set of one or more criteria and the second set of one or more devices does not meet the respective set of one or more criteria, causing the first set of one or more devices to provide output indicating the position of the object in an environment without causing the second set of one or more devices to provide output indicating the position of the object in the environment; and in accordance with a determination that the first set of one or more devices does not meet the respective set of one or more criteria and the second set of one or more meets the respective set of one or more criteria, causing the second set of one or more devices to provide output indicating the position of the object in the environment without causing the first set of one or more devices to provide output indicating the position of the object in the environment.

In some embodiments, a computer system that is in communication with a display component, a first set of one or more devices that does not include an object, a second set of one or more devices that does not include the object, and one or more input devices is described. In some embodiments, the computer system that is in communication with a display component, a first set of one or more devices that does not include an object, a second set of one or more devices that does not include the object, and one or more input devices comprises means for performing each of the following steps: detecting, via the one or more input devices, a request to identify a location of the object; and in response to detecting the request to identify the location of the object: in accordance with a determination that the first set of one or more devices meets a respective set of one or more criteria and the second set of one or more devices does not meet the respective set of one or more criteria, causing the first set of one or more devices to provide output indicating the position of the object in an environment without causing the second set of one or more devices to provide output indicating the position of the object in the environment; and in accordance with a determination that the first set of one or more devices does not meet the respective set of one or more criteria and the second set of one or more meets the respective set of one or more criteria, causing the second set of one or more devices to provide output indicating the position of the object in the environment without causing the first set of one or more devices to provide output indicating the position of the object in the environment.

In some embodiments, a computer program product is described. In some embodiments, the computer program product comprises one or more programs configured to be executed by one or more processors of a computer system that is in communication with a display component, a first set of one or more devices that does not include an object, a second set of one or more devices that does not include the object, and one or more input devices. In some embodiments, the one or more programs include instructions for: detecting, via the one or more input devices, a request to identify a location of the object; and in response to detecting the request to identify the location of the object: in accordance with a determination that the first set of one or more devices meets a respective set of one or more criteria and the second set of one or more devices does not meet the respective set of one or more criteria, causing the first set of one or more devices to provide output indicating the position of the object in an environment without causing the second set of one or more devices to provide output indicating the position of the object in the environment; and in accordance with a determination that the first set of one or more devices does not meet the respective set of one or more criteria and the second set of one or more meets the respective set of one or more criteria, causing the second set of one or more devices to provide output indicating the position of the object in the environment without causing the first set of one or more devices to provide output indicating the position of the object in the environment.

In some embodiments, a method that is performed at a computer system that is in communication a first set of one or more devices that does not include an object is described. In some embodiments, the method comprises: while causing the first set of one or more devices to provide first output that indicates where the object is located, detecting a change in a positional relationship between a first user and the object; and in response to detecting the change in the positional relationship between the first user and the object, causing the first set of one or more devices to provide second output that indicates where the object is located, wherein the second output is different from the first output.

In some embodiments, a non-transitory computer-readable storage medium storing one or more programs configured to be executed by one or more processors of a computer system that is in communication a first set of one or more devices that does not include an object is described. In some embodiments, the one or more programs includes instructions for: while causing the first set of one or more devices to provide first output that indicates where the object is located, detecting a change in a positional relationship between a first user and the object; and in response to detecting the change in the positional relationship between the first user and the object, causing the first set of one or more devices to provide second output that indicates where the object is located, wherein the second output is different from the first output.

In some embodiments, a transitory computer-readable storage medium storing one or more programs configured to be executed by one or more processors of a computer system that is in communication a first set of one or more devices that does not include an object is described. In some embodiments, the one or more programs includes instructions for: while causing the first set of one or more devices to provide first output that indicates where the object is located, detecting a change in a positional relationship between a first user and the object; and in response to detecting the change in the positional relationship between the first user and the object, causing the first set of one or more devices to provide second output that indicates where the object is located, wherein the second output is different from the first output.

In some embodiments, a computer system that is in communication a first set of one or more devices that does not include an object is described. In some embodiments, the computer system that is in communication a first set of one or more devices that does not include an object comprises one or more processors and memory storing one or more programs configured to be executed by the one or more processors. In some embodiments, the one or more programs includes instructions for: while causing the first set of one or more devices to provide first output that indicates where the object is located, detecting a change in a positional relationship between a first user and the object; and in response to detecting the change in the positional relationship between the first user and the object, causing the first set of one or more devices to provide second output that indicates where the object is located, wherein the second output is different from the first output.

In some embodiments, a computer system that is in communication a first set of one or more devices that does not include an object is described. In some embodiments, the computer system that is in communication a first set of one or more devices that does not include an object comprises means for performing each of the following steps: while causing the first set of one or more devices to provide first output that indicates where the object is located, detecting a change in a positional relationship between a first user and the object; and in response to detecting the change in the positional relationship between the first user and the object, causing the first set of one or more devices to provide second output that indicates where the object is located, wherein the second output is different from the first output.

In some embodiments, a computer program product is described. In some embodiments, the computer program product comprises one or more programs configured to be executed by one or more processors of a computer system that is in communication a first set of one or more devices that does not include an object. In some embodiments, the one or more programs include instructions for: while causing the first set of one or more devices to provide first output that indicates where the object is located, detecting a change in a positional relationship between a first user and the object; and in response to detecting the change in the positional relationship between the first user and the object, causing the first set of one or more devices to provide second output that indicates where the object is located, wherein the second output is different from the first output.

In some embodiments, a method that is performed at a computer system that is in communication with a first set of one or more devices is described. In some embodiments, the method comprises: while causing the first set of one or more devices to operate in a first manner, detecting a first movement of a user; and in response to detecting the first movement of the user: in accordance with a determination that a first context is present, causing the first set of one or more devices to operate in a second manner that is different from the first manner; and in accordance with a determination that a second context is present, causing the first set of one or more devices to operate in a third manner different from the second manner and the first manner.

In some embodiments, a non-transitory computer-readable storage medium storing one or more programs configured to be executed by one or more processors of a computer system that is in communication with a first set of one or more devices is described. In some embodiments, the one or more programs includes instructions for: while causing the first set of one or more devices to operate in a first manner, detecting a first movement of a user; and in response to detecting the first movement of the user: in accordance with a determination that a first context is present, causing the first set of one or more devices to operate in a second manner that is different from the first manner; and in accordance with a determination that a second context is present, causing the first set of one or more devices to operate in a third manner different from the second manner and the first manner.

In some embodiments, a transitory computer-readable storage medium storing one or more programs configured to be executed by one or more processors of a computer system that is in communication with a first set of one or more devices is described. In some embodiments, the one or more programs includes instructions for: while causing the first set of one or more devices to operate in a first manner, detecting a first movement of a user; and in response to detecting the first movement of the user: in accordance with a determination that a first context is present, causing the first set of one or more devices to operate in a second manner that is different from the first manner; and in accordance with a determination that a second context is present, causing the first set of one or more devices to operate in a third manner different from the second manner and the first manner.

In some embodiments, a computer system that is in communication with a first set of one or more devices is described. In some embodiments, the computer system that is in communication with a first set of one or more devices comprises one or more processors and memory storing one or more programs configured to be executed by the one or more processors. In some embodiments, the one or more programs includes instructions for: while causing the first set of one or more devices to operate in a first manner, detecting a first movement of a user; and in response to detecting the first movement of the user: in accordance with a determination that a first context is present, causing the first set of one or more devices to operate in a second manner that is different from the first manner; and in accordance with a determination that a second context is present, causing the first set of one or more devices to operate in a third manner different from the second manner and the first manner.

In some embodiments, a computer system that is in communication with a first set of one or more devices is described. In some embodiments, the computer system that is in communication with a first set of one or more devices comprises means for performing each of the following steps: while causing the first set of one or more devices to operate in a first manner, detecting a first movement of a user; and in response to detecting the first movement of the user: in accordance with a determination that a first context is present, causing the first set of one or more devices to operate in a second manner that is different from the first manner; and in accordance with a determination that a second context is present, causing the first set of one or more devices to operate in a third manner different from the second manner and the first manner.

In some embodiments, a computer program product is described. In some embodiments, the computer program product comprises one or more programs configured to be executed by one or more processors of a computer system that is in communication with a first set of one or more devices. In some embodiments, the one or more programs include instructions for: while causing the first set of one or more devices to operate in a first manner, detecting a first movement of a user; and in response to detecting the first movement of the user: in accordance with a determination that a first context is present, causing the first set of one or more devices to operate in a second manner that is different from the first manner; and in accordance with a determination that a second context is present, causing the first set of one or more devices to operate in a third manner different from the second manner and the first manner.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for displaying controls, thereby increasing the effectiveness, efficiency, and user satisfaction with such devices. Such methods and interfaces may complement or replace other methods for displaying controls.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2C illustrate exemplary user interfaces for providing controls in different contexts in accordance with some embodiments.

FIG. 3 is a flow diagram illustrating a method for selectively providing controls in accordance with some embodiments.

FIG. 4 is a flow diagram illustrating a method for providing an indication of a state of a computer system in accordance with some embodiments.

FIGS. 5A-5C illustrate exemplary user interfaces for locating objects in accordance with some embodiments.

FIG. 6 is a flow diagram illustrating a method for locating objects in accordance with some embodiments.

FIGS. 7A-7C illustrate techniques for selectively providing feedback in accordance with some embodiments.

FIG. 8 is a flow diagram illustrating a method for adjusting output of devices in accordance with some embodiments.

FIG. 9 is a flow diagram illustrating a method for providing contextual based feedback in accordance with some embodiments.

### DETAILED DESCRIPTION

The following description sets forth exemplary techniques for providing controls. This description is not intended to limit the scope of this disclosure but is instead provided as a description of example implementations.

Users need electronic devices that provide effective techniques for providing controls. Efficient techniques can reduce a user's mental load when accessing provided controls. This reduction in mental load can enhance user productivity and make the device easier to use. In some embodiments, the techniques described herein can reduce battery usage and processing time (e.g., by providing user interfaces that require fewer user inputs to operate).

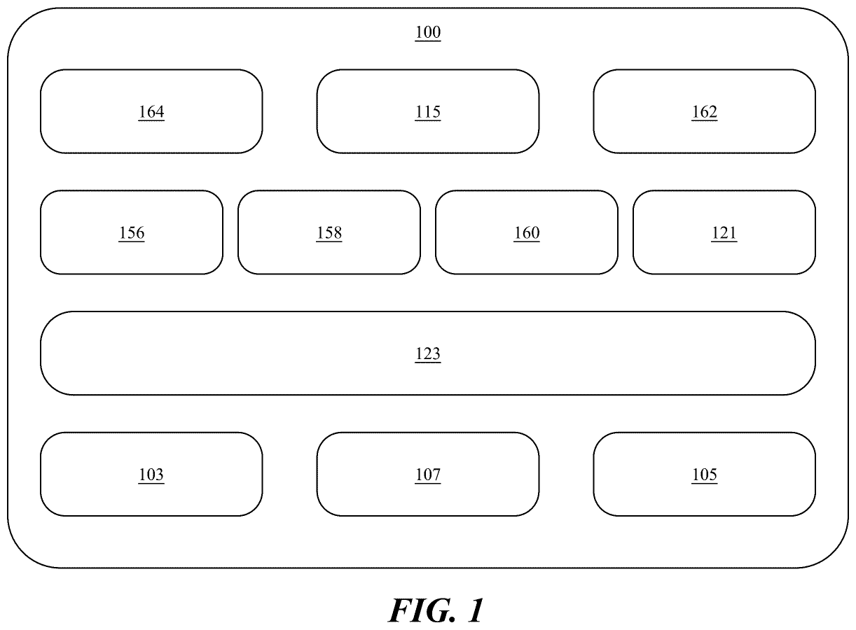

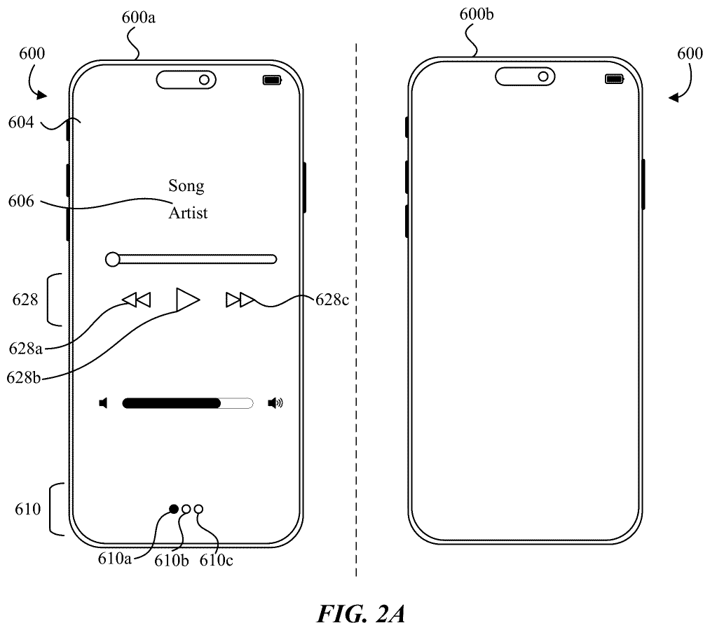

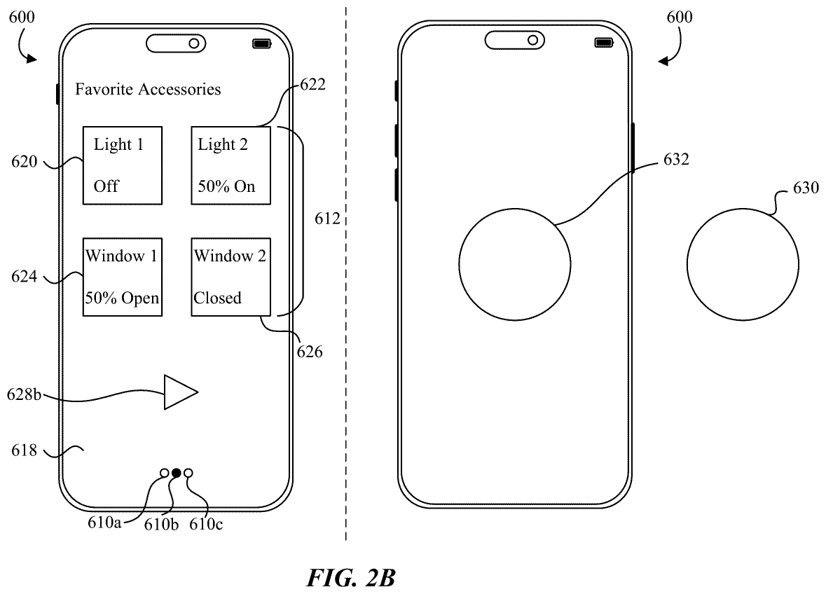

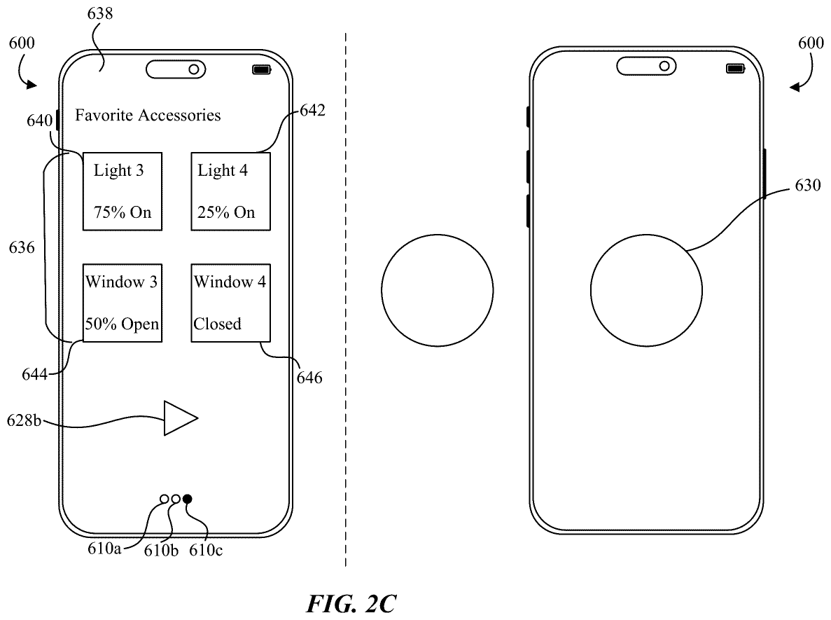

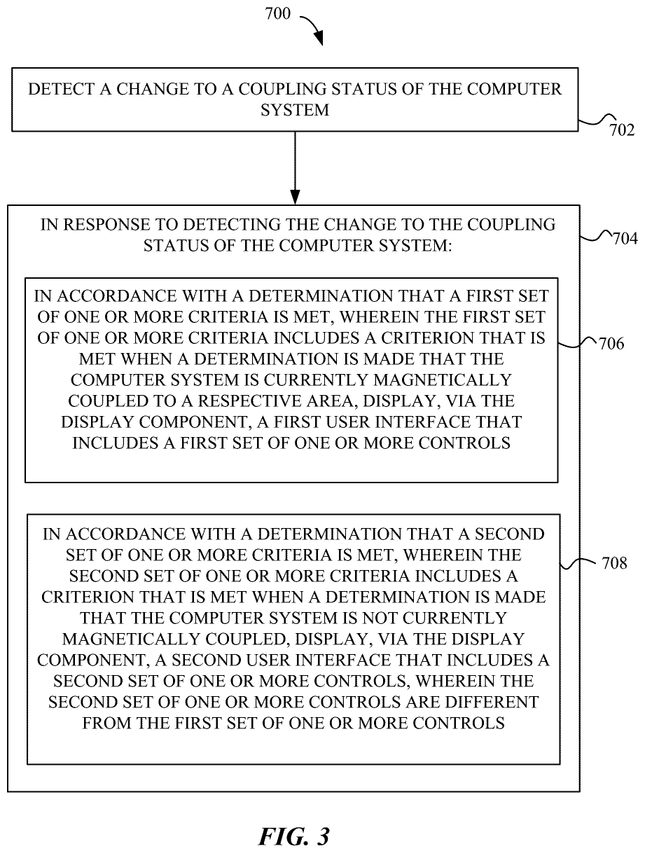

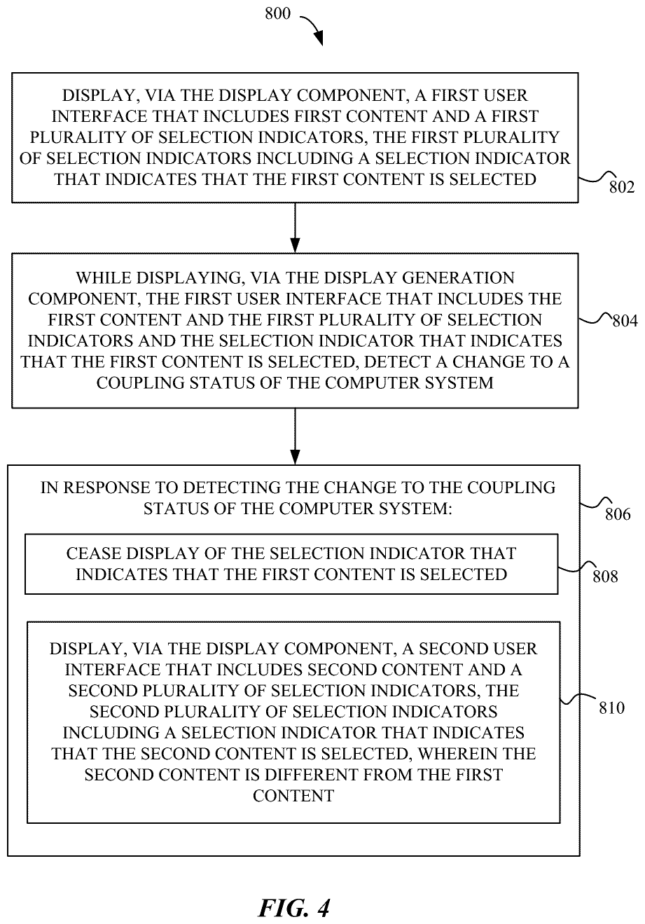

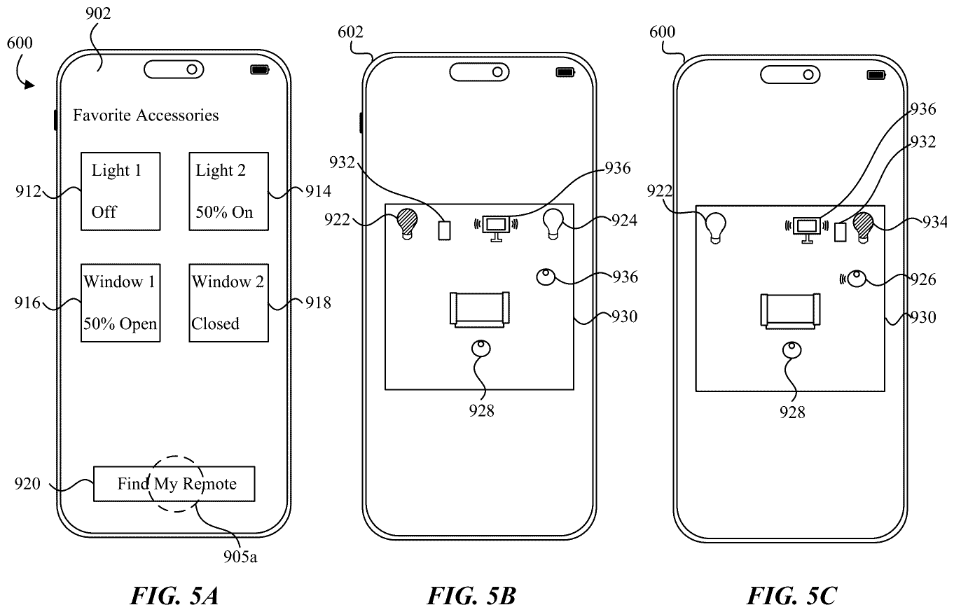

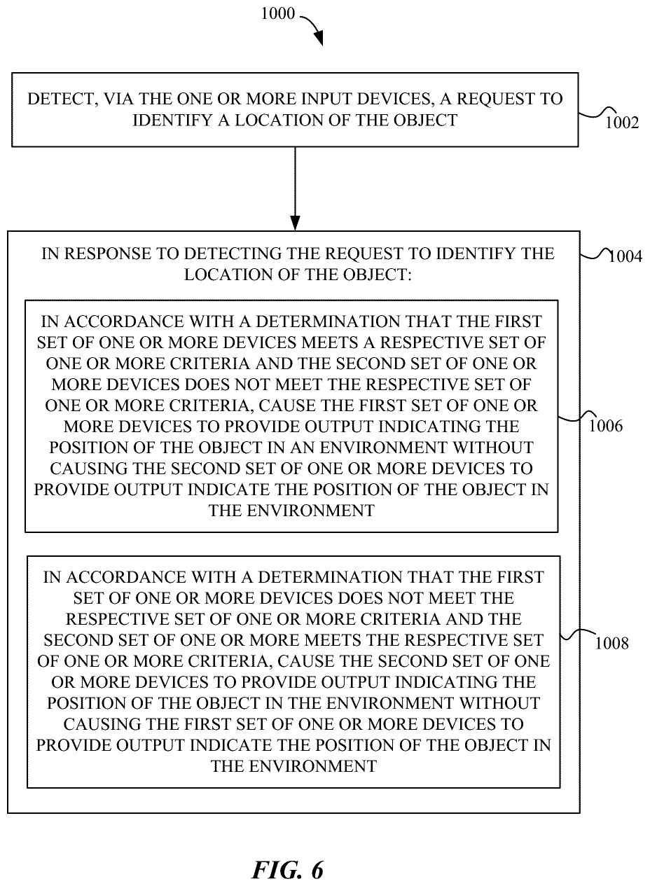

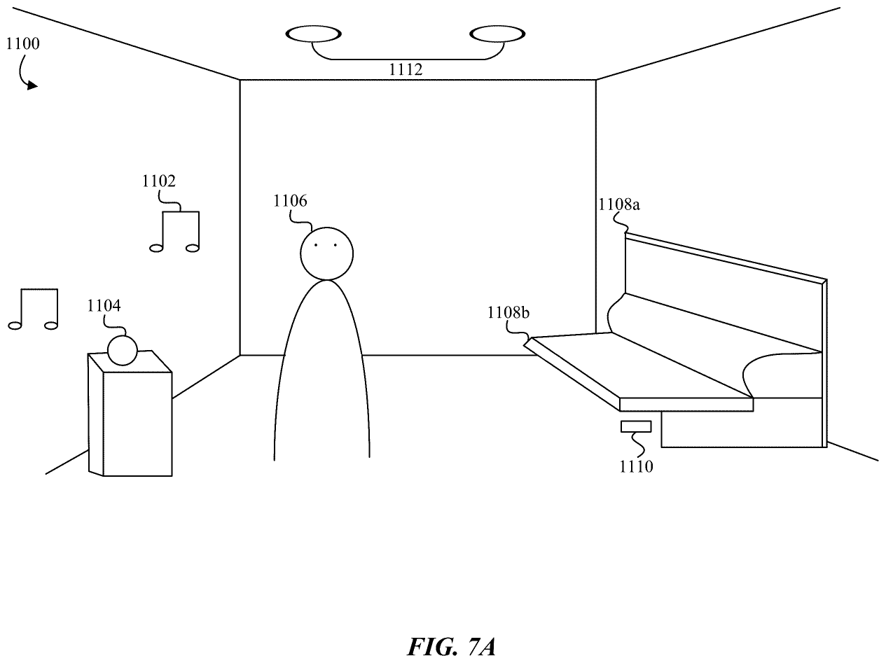

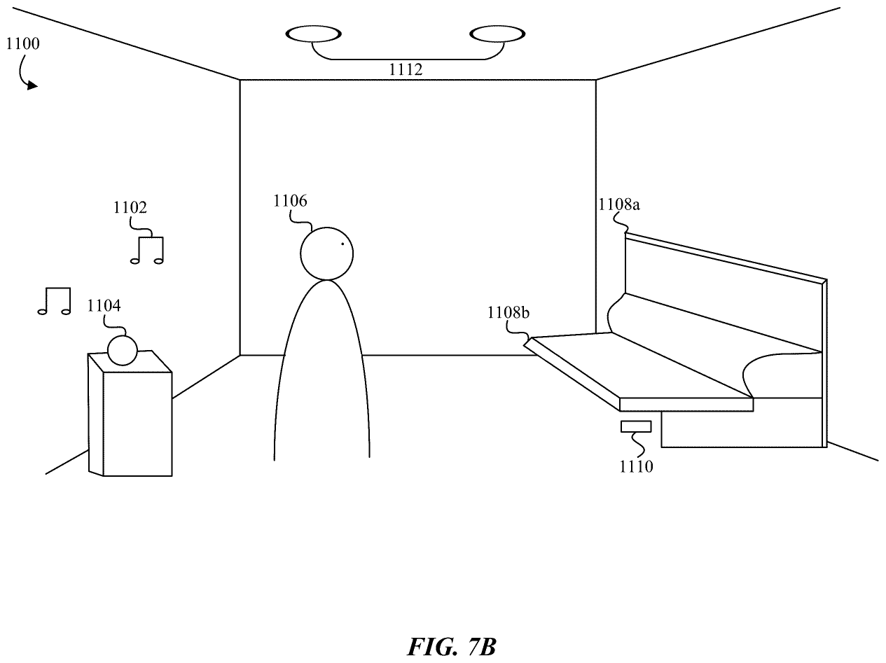

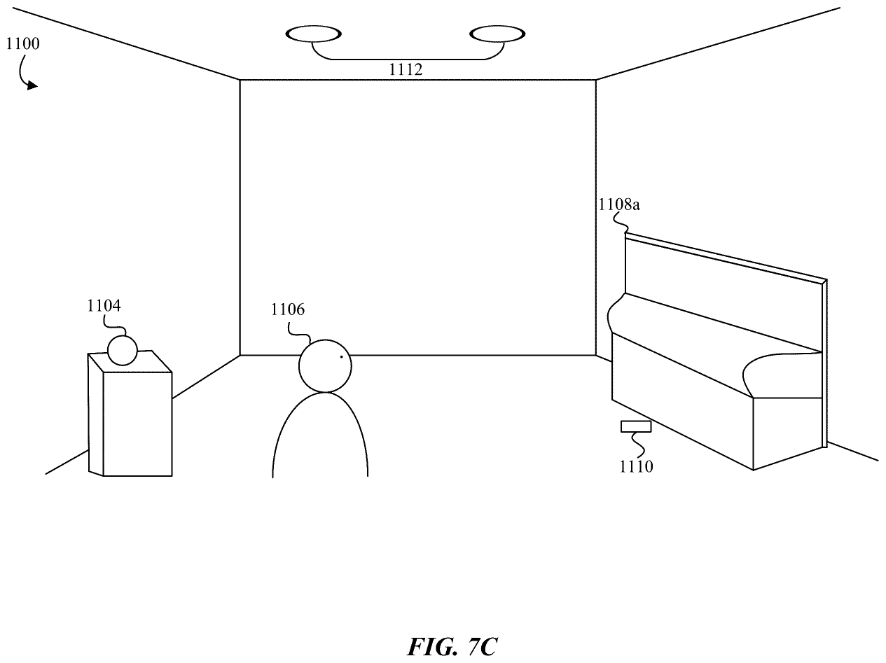

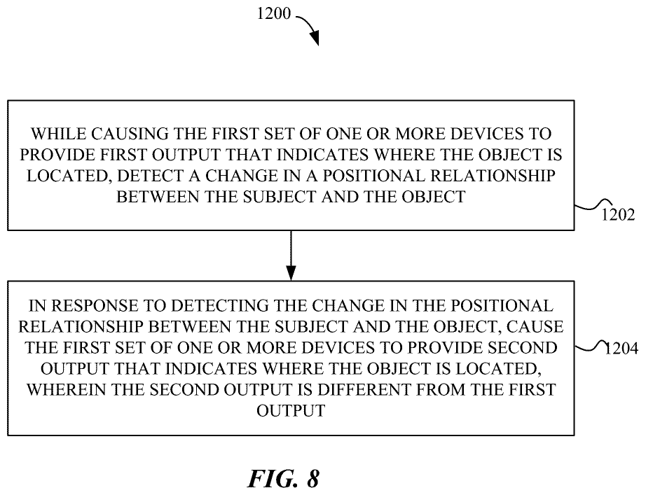

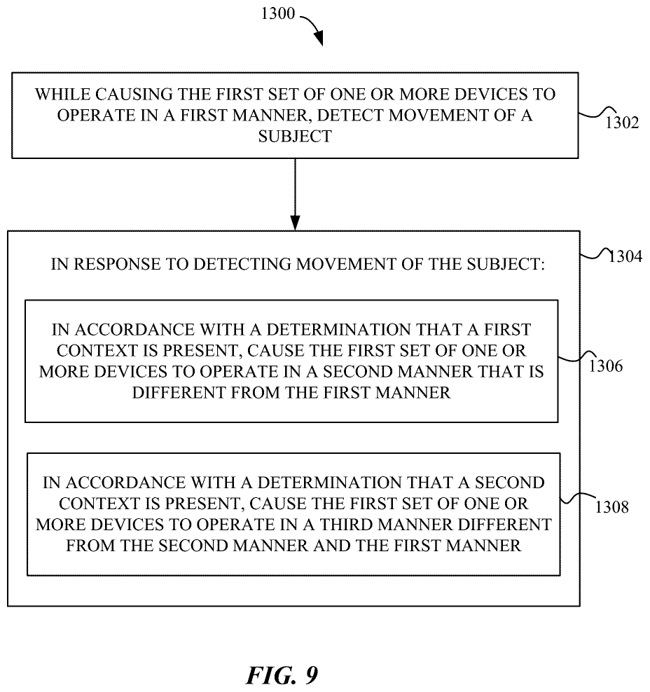

FIG. 1 provides illustrations of exemplary devices for performing techniques for providing controls. FIGS. 2A-2C illustrate exemplary user interfaces for providing controls in different contexts in accordance with some embodiments. FIG. 3 is a flow diagram illustrating a method for selectively providing controls in accordance with some embodiments. FIG. 4 is a flow diagram illustrating a method for providing an indication of a state of a computer system in accordance with some embodiments. The user interfaces in FIGS. 2A-2C are used to illustrate the processes described below, including the processes in FIGS. 3 and/or 4. FIGS. 5A-5C illustrate exemplary user interfaces for locating objects in accordance with some embodiments. FIG. 6 is a flow diagram illustrating a method for locating objects in accordance with some embodiments. The user interfaces in FIGS. 5A-5C are used to illustrate the processes described below, including the processes in FIG. 6. FIGS. 7A-7C illustrate techniques for selectively providing feedback in accordance with some embodiments. FIG. 8 is a flow diagram illustrating a method for adjusting output of devices in accordance with some embodiments. FIG. 9 is a flow diagram illustrating a method for providing contextual based feedback in accordance with some embodiments. The user interfaces in FIGS. 7A-7C are used to illustrate the processes described below, including the processes in FIGS. 8 and/or 9.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates system 100 for implementing techniques described herein. System 100 can perform any of the methods described in FIGS. 3, 4, 5, 6, and/or 7 (e.g., processes 700, 800, 1000, 1200, and/or 1300) and/or portions of these methods.

In FIG. 1, system 100 includes various components, such as processor(s) 103, RF circuitry (ies) 105, memory (ies) 107, sensors 156 (e.g., image sensor(s), orientation sensor(s), location sensor(s), heart rate monitor(s), temperature sensor(s)), input device(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output device(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input device.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory (ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry (ies) 105 includes circuitry for communicating with electronic devices and/or networks (e.g., the Internet, intranets, and/or a wireless network, such as cellular networks and wireless local area networks (LANs)). In some embodiments, RF circuitry (ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform 150. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100. In some embodiments, input device(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100. In some embodiments, environmental controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery (ies)), transmission(s), suspension system(s), speed control system(s), and/or steering system(s). In some embodiments, one or more elements of mobility component(s) are configured to be controlled autonomously or manually (e.g., via system 100 and/or input device(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry (ies) 105.

In some embodiments, system 100 is capable of communicating with other computer systems and/or electronic devices. For example, system 100 can use RF circuitry (ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry (ies) 105. In some embodiments, system 100 receives, using the RF circuitry (ies) 105, video and/or audio from the other system(s) in the videoconferencing communication sessions, and presents the video and/or audio using output device(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output device(s) 160. In some embodiments, output device(s) 160 generates the tactile outputs by displacing a moveable mass relative to a neutral position. In some embodiments, tactile outputs are periodic in nature, optionally including frequency (ies) and/or amplitude(s) of movement in two or three dimensions. In some embodiments, system 100 generates a variety of different tactile outputs differing in frequency (ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency (ies) corresponds to faster movement(s) by the moveable mass whereas lower frequency (ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input device(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input device(s) 158 to detect the user speaking one or more words. In some embodiments, system 100 parses and/or communicates information to one or more other systems to determine contents of the speech of the user, including identifying words and/or obtaining a semantic understanding of the words. For example, processor(s) 103 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output device(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry (ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as the system 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry (ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

FIGS. 2A-2C illustrate exemplary user interfaces for providing controls in different contexts in accordance with some embodiments. The user interfaces in these figures are used to illustrate the processes described below, including the processes in FIGS. 3-4.

FIG. 2A illustrates computer system 600, including frontside 600a of computer system 600 and backside 600b of computer system 600. In some embodiments, computer system 600 is a smartphone and includes display 604 (e.g., a display component). In some embodiments, display 604 is a touch-sensitive display. In some embodiments, computer system 600 includes one or more input devices, such as a knob, a dial, a joystick, a touch-sensitive surface, a button, and/or a slider. It should be understood that the types of computer systems and/or components described herein are merely exemplary and are provided to give context to the embodiments described herein. In some embodiments, computer system 600 includes one or more features and/or components as described above with respect to system 100.

As illustrated in FIG. 2A, computer system 600 is not coupled to an external charger (e.g., as indicated by the absence of an external charger on backside 600b of computer system 600). At FIG. 2A, computer system 600 is located at a first area within a physical structure (e.g., a building, a home, an airplane, and/or a vehicle). In some embodiments, the physical structure includes one or more output devices, such as lights, playback devices, and/or windows. Computer system 600 can be in communication (e.g., wireless communication (e.g., Wi-Fi, Bluetooth, and/or Ultrawideband) and/or wired communication) with the one or more output devices within the physical structure.

As illustrated in FIG. 2A, computer system 600 displays media playback user interface 606. Media playback user interface 606 includes media playback controls 628. Media playback controls 628 corresponds to one or more playback devices (e.g., speaker devices) that are positioned throughout the physical structure (e.g., the one or more playback devices are positioned in the first area of the physical structure and/or in other areas of the physical structure). Media playback controls 628 can be selected to modify the playback status of the one or more playback devices.

Media playback controls 628 includes previous media item user interface object 628a, playback control user interface object 628b, and next media item user interface object 628c. It should be recognized that such controls are just examples and that other objects can be used with techniques described herein. In some embodiments, each of previous media item user interface object 628a, playback control user interface object 628b, and next media item user interface object 628c are global controls. In some embodiments, a global control corresponds to (e.g., configured to control) one or more devices that are positioned throughout various areas in the physical structure (e.g., global controls correspond to devices that are in different areas of the physical structure). In some embodiments, computer system 600 transmits instructions to the one or more playback devices that adjust the playback status of the one or more playback device in response to detecting an input that corresponds to selection of previous media item user interface object 628a, playback control user interface object 628b, or next media item user interface object 628c.

In some embodiments, media playback user interface 606 corresponds to a first user interface in a series of user interfaces. As illustrated in FIG. 2A, media playback user interface 606 includes paging indicator user interface object 610. Paging indicator user interface object 610 includes first paging indicator 610a, second paging indicator 610b, and third paging indicator 610c. Each paging indicator in paging indicator user interface object 610 corresponds to a respective user interface in the series of user interfaces. As illustrated in FIG. 2A, computer system 600 displays first paging indicator 610a as visually emphasized (e.g., first paging indicator 610a is filled in, and second paging indicator 610b and third paging indicator 610c are not filled in). Computer system 600 does not display second paging indicator 610b and/or third paging indicator 610c as visually emphasized while computer system 600 displays first paging indicator 610a as visually emphasized. In some embodiments, computer system 600 displays one of first paging indicator 610a, second paging indicator 610b, and third paging indicator 610c as visually emphasized based on which user interface in the series of user interfaces computer system 600 is being displayed.

At FIG. 2B, computer system 600 transitions from being uncoupled to external charger 632 to being coupled to external charger 632, and computer system 600 is moved to a second area (e.g., that is different from or the same as the first area) within the physical structure. In some embodiments, the first area and the second area are located on opposite sides of the physical structure (e.g., the first area is located on the left side of a home and the second area is located on the right side of a home or the first area is located at the front of an airplane and the second area is located at the rear of the airplane).

At FIG. 2B, a determination is made that computer system 600 transitions from being uncoupled to external charger 632 to being coupled to external charger 632. Because a determination is made that computer system 600 transitions from being uncoupled to external charger 632 to being coupled to external charger 632, computer system 600 ceases to display media playback user interface 606 and displays first controls user interface 618 (e.g., computer system 600 scrolls from media playback user interface 606 to first controls user interface 618 in the series of user interfaces). At FIG. 2B, computer system 600 is coupled to external charger 632 via a magnetic connection. First controls user interface 618 corresponds to the second user interface in the series of user interfaces. In some embodiments, computer system 600 redisplays media playback user interface 606 in response to detecting a swipe input (e.g., a rightward swipe input) while computer system 600 displays first controls user interface 618. In some embodiments, computer system 600 redisplays media playback user interface 606 in response to detecting that computer system 600 is uncoupled from external charger 632 while computer system 600 displays first controls user interface 618. In some embodiments, a background color, pattern, and/or in image of a user interface being displayed changed depending on whether computer system 600 is coupled to external charger 632. For example, a background color of a user interface being displayed while computer system 600 is coupled to external charger 632 can be a first color while a background color of a user interface being displayed while computer system 600 is not coupled to external charger 632 can be a second color different from the first color.

Further, at FIG. 2B, because a determination is made that computer system 600 transitions from being uncoupled to external charger 632 to being coupled to external charger 632, computer system 600 displays second paging indicator 610b as visually emphasized. At FIG. 2B, computer system 600 ceases to display first paging indicator 601a as visually emphasized as part of displaying second paging indicator 610b as visually emphasized. In some embodiments, in accordance with a determination that computer system 600 transitions from being uncoupled to external charger 632 to being coupled to external charger 632, computer system 600 transitions from a first operating mode to a second operating mode (e.g., computer system 600 transitions from a sleep state or an off state to an active/display state). In some embodiments, computer system 600 displays second paging indicator 610b as visually emphasized in accordance with a determination that computer system 600 displays the second user interface in the series of user interfaces.

At FIG. 2B, a determination is made that computer system 600 is positioned in the second area of the physical structure. Because a determination is made that computer system 600 is positioned in the second area of the physical structure, computer system 600 displays first controls user interface 618 with first set of controls 612. First set of controls 612 includes first light control user interface object 620, second light control user interface object 622, first window control user interface object 624, second window control user interface object 626, and playback control user interface object 628b. First light control user interface object 620 corresponds to (e.g., is configured to control) a first light device, second light control user interface object 622 corresponds to (e.g., is configured to control) a second light device, first window control user interface object 624 corresponds to (e.g., is configured to control) first window, and second window control user interface object 626 corresponds to (e.g., is configured to control) a second window. In some embodiments, each of the first light device, the second light device, the first window, and the second window are positioned within the second area of the physical structure. That is, when computer system 600 is positioned in the second area of the physical structure and coupled to external charger 632, computer system 600 displays control user interface objects that correspond to devices that are located in the second area of the physical structure. In some embodiments, computer system 600 transmits instructions to the first light device that adjusts the operation of the light device in response to detecting an input (e.g., a tap input, swipe input, rotation of a rotatable input device, gaze, voice command and/or hand gesture) that corresponds to selection of first light control user interface object 620. In some embodiments, computer system 600 does not display first controls user interface 618 with first set of controls 612 when a determination is made that the second area of the physical structure does not include any controllable accessories. In some embodiments, computer system 600 displays media playback user interface 606 in response to detecting an input that corresponds to selection of playback control user interface object 628b while computer system 600 displays first controls user interface 618.

In some embodiments, each of first light control user interface object 620, second light control user interface object 622, first window control user interface object 624, and second window control user interface object 626 are local controls. In some embodiments, in contrast to a global control (e.g., as explained above), a local control corresponds to (e.g., is configured to control) one or more devices that are positioned in a particular area of the physical structure (e.g., the second area). In some embodiments, first controls user interface 618 includes local controls and not global controls (e.g., first controls user interface 618 includes first light control user interface object 620, second light control user interface object 622, first window control user interface object 624, and second window control user interface object 626 and does not include playback control user interface object 628b). In some embodiments, first controls user interface 618 includes global controls and not local controls. In some embodiments, first controls user interface 618 includes a combination of one or more global controls and one or more local controls.

As illustrated in FIG. 2B, each of first light control user interface object 620, second light control user interface object 622, first window control user interface object 624, and second window control user interface object 626 include an indication of the status of the device that corresponds to the respective control user interface object. That is, first light control user interface object 620 indicates that the first light device is powered off, second light control user interface object 622 indicates that the second light device is operating at 50% brightness, first window control user interface object 624 indicates that the first window is halfway open, and second window control user interface object 626 indicates that the second window is closed. In some embodiments, computer system 600 updates the status indicator included in first light control user interface object 620, second light control user interface object 622, first window control user interface object 624, and/or second window control user interface object 626 in accordance with a determination that operation of the corresponding device changes. In some embodiments, first set of controls 612 includes control user interface objects based on which accessories are positioned within the second area of the physical structure. In some embodiments, the second area of the physical structure includes multiple sub-areas (e.g., if the physical structure is a home, the second area includes a number of rooms on a respective floor of the home) and computer system 600 displays first set of controls 612 irrespective of what sub-area of the second area computer system 600 is located within. In some embodiments, when the second area of the physical structure encompasses multiple sub-areas, computer system 600 displays a respective set of controls based on what sub-area of the second area computer system 600 is positioned within and what accessories are located in the sub-area of the second area. At FIG. 2B, computer system 600 transitions from being coupled to external charger 632 to being coupled to external charger 630 and is moved from the second area in the physical structure to a third area in the physical structure. In some embodiments, the second area and the third area are located on opposite sides of the physical structure (e.g., the second area is located on the left side of a room and the third area is located on the right side of the room).

At FIG. 2C, a determination is made that computer system 600 transitions from being coupled to external charger 632 to being coupled to external charger 630. Because a determination is made that computer system 600 transitions from being coupled to external charger 632 to being coupled to external charger 630, computer system 600 ceases to display first controls user interface 618 and displays second controls user interface 638 (e.g., computer system 600 scrolls from first controls user interface 618 to second controls user interface 638). In some embodiments, computer system 600 does not display first controls user interface 618 and/or first set of controls 612 while computer system 600 is coupled to external charger 630. At FIG. 2C, computer system 600 is coupled to external charger 630 via a magnetic connection. In some embodiments, while displaying second controls user interface 638, computer system 600 redisplays media playback user interface 606 in response to detecting that computer system 600 transitions from being coupled to external charger 630 to being uncoupled to a respective external charger. In some embodiments, while computer system 600 displays first controls user interface 618, computer system 600 displays second controls user interface 638 in response to detecting a swipe input (e.g., a leftward swipe input). In some embodiments, computer system 600 is coupled to external charger 630 via a wired connection (e.g., external charger 630 is inserted into computer system 600). In some embodiments, a determination that computer system 600 transitions from being coupled to external charger 632 to being coupled to external charger 630 includes a determination that computer system 600 is coupled a specific location (e.g., the location of external charger 630) of the physical structure.

Further, at FIG. 2C, because a determination is made that computer system 600 transitions from being coupled to external charger 632 to being coupled to external charger 630, computer system 600 ceases to display second paging indicator 610b as visually emphasized and computer system 600 displays third paging indicator 610c as visually emphasized. Second controls user interface 638 corresponds to the third user interface in the series of user interfaces.

External charger 630 is positioned within the third area of the physical structure that is different from the first and/or second area of the physical structure. At FIG. 2C, a determination is made that computer system 600 is positioned within the third area of the physical structure. Because a determination is made that computer system 600 is positioned within the third area of the physical structure, second controls user interface 638 includes second set of controls 636. Second set of controls 636 corresponds to accessories positioned in the third area of the physical structure. Second set of controls 636 includes different control user interface objects than the control user interface objects included in first set of controls 612.

Second set of controls 636 includes third light control user interface object 640, fourth light control user interface object 642, third window control user interface object 644, fourth window control user interface object 646, and playback control user interface object 628b. Each of third light control user interface object 640, fourth light control user interface object 642, third window control user interface object 644, fourth window control user interface object 646 are local controls while, as explained above, playback control user interface object 628b is a global control. Accordingly, second set of controls 636 includes both local and global controls. Third light control user interface object 640 corresponds to a third light device, fourth light control user interface object 642 corresponds to a fourth light device, third window control user interface object 644 corresponds to a third window, and fourth window control user interface object 646 corresponds to a fourth window. Each of the third light device, the fourth light device, the third window, and the fourth window are positioned in the second area of the physical structure. In some embodiments, second set of controls 636 includes one or more control user interface objects that are not included in first set of controls 612 or vice versa. In some embodiments, second set of controls 636 and first set of controls 612 have a common control user interface object. In some embodiments, second set of controls 636 and first set of controls 612 do not have a common control user interface object. In some embodiments, computer system 600 transmits instructions to a corresponding device that adjust operation of the corresponding device in response to detecting that one of third light control user interface object 640, fourth light control user interface object 642, third window control user interface object 644, or fourth window control user interface object 646 is selected. In some embodiments, in response to detecting an input that corresponds to a selection of one of third light control user interface object 640, fourth light control user interface object 642, third window control user interface object 644, fourth window control user interface object 646, computer system 600 does not update display of the selected control user interface object (e.g., computer system 600 does not update display of the selected control user interface object to represent the change in the operation of the corresponding accessory). In some embodiments, second set of controls 636 includes one or more media control user interface objects (e.g., that, when selected, cause computer system 600 to transmit instructions to one or more playback devices that modify playback status of one or more playback devices) that are not included in first set of controls 612. In some embodiments, first set of controls 612 includes one or more temperature control user interface objects (e.g., that, when selected, cause computer system 600 to transmit instructions to an air conditioning device (e.g., a device capable of heating and cooling) that modify a temperature setting of the air conditioning device) that are not included in second set of controls 636. In some embodiments, when the first area of the physical structure is within the second area of the physical structure (e.g., the second area of the physical structure encompasses the first area of the physical structure), second set of controls 636 includes one or more of first light control user interface object 620, second light control user interface object 622, first window control user interface object 624, and/or second window control user interface object 626. In some embodiments, computer system 600 displays second set of controls 636 and first set of controls 612 in the same position on display 604. In some embodiments, as part of displaying second controls user interface 638, computer system 600 displays an animation of second set of controls 636 replacing first set of controls 612. In some embodiments, when computer system 600 displays an animation of second set of controls 636 replacing first set of controls 612, computer system 600 displays first set of controls 612 as scrolling (e.g., scrolling upwards, downwards, to the left, and/or to the right) as part of displaying the animation.

FIG. 3 is a flow diagram illustrating a method (e.g., process 700) for selectively providing controls in accordance with some embodiments. Some operations in process 700 are, optionally, combined, the orders of some operations are, optionally, changed, and some operations are, optionally, omitted.

As described below, process 700 provides an intuitive way for selectively providing controls. Process 700 reduces the cognitive burden on a user for interacting with a computer system, thereby creating a more efficient human-machine interface. For battery-operated computing devices, enabling a user to interact with a computer system faster and more efficiently conserves power and increases the time between battery charges.

In some embodiments, process 700 is performed at a computer system (e.g., 100 and/or 600) that is in communication with a display component (e.g., 604) (e.g., a display screen and/or a touch-sensitive display). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

The computer system detects (702) a change to a coupling status (e.g., a magnetic coupling status, a wireless coupling status, and/or a wired coupling status) of the computer system (and/or detecting a request to display a user interface (e.g., a request to wake the computer system)) (e.g., as described above with respect to 630 and/or 632).

In response to (704) detecting the change to the coupling status of the computer system (and, in some embodiments, while displaying, via the display component, a first user interface and/or and in response to detecting presence (e.g., detecting that a user and/or device associated with the user is within a predetermined distance (e.g., 1-5 meters) from the computer system) of a user) (and/or in response to detecting a request to display a user interface (e.g., a request to wake the computer system)), in accordance with a determination that a first set of one or more criteria is met, wherein the first set of one or more criteria includes a criterion that is met when a determination is made that the computer system is currently magnetically coupled to (e.g., connected to, linked to, and/or attached to) a respective area (e.g., directly magnetically coupled and/or coupled because its touching a magnetic at the respective area) (e.g., as described above with respect to FIG. 2B or 2C), the computer system displays (706), via the display component, a first user interface (e.g., 618 or 638) that includes a first set of one or more controls (e.g., 612 or 636). In some embodiments, the first user interface and/or the first set of one or more controls are displayed around a rotatable input mechanism. In some embodiments, a background of at least a portion of the second user interface has a first appearance in accordance with a determination that the first set of one or more criteria is met.

In response to (704) detecting the change to the coupling status of the computer system, in accordance with a determination that a second set of one or more criteria is met, wherein the second set of one or more criteria includes a criterion that is met when a determination is made that the computer system is not currently magnetically coupled (e.g., as described above with respect to FIG. 2A or 2C), the computer system displays (708), via the display component, a second user interface (e.g., 606) that includes a second set of one or more controls (e.g., 628), wherein the second set of one or more controls are different from the first set of one or more controls. In some embodiments, the first user interface is different from a user interface that is displayed by the computer system before the change in the coupling status of the computer system was detected. In some embodiments, the first user interface is the same a user interface that is displayed by the computer system before the change in the coupling status of the computer system was detected. In some embodiments, the second user interface is different from a user interface that is displayed by the computer system before the change in the coupling status of the computer system was detected. In some embodiments, the second user interface is the same as a user interface that is displayed by the computer system before the change in the coupling status of the computer system was detected. In some embodiments, the first user interface does not include one or more controls in the second set of one or more controls. In some embodiments, the second user interface does not include one or more controls in the first set of one or more controls. In some embodiments, the second user interface is different from the first user interface. Displaying different sets of one or more controls in accordance with a determination of whether the computer system is currently magnetically coupled allows for the set of one or more controls that is displayed to be relevant to a current situation and/or location in which the computer system is magnetically coupled, thereby reducing the number of inputs needed to perform an operation, providing additional control options without cluttering the user interface with additional displayed controls, and/or performing an operation when a set of conditions has been met without requiring further user input. In some embodiments, the second user interface and/or the second set of one or more controls are displayed around the rotatable input mechanism. In some embodiments, a background of at least a portion of the second user interface has a second appearance in accordance with a determination that the second set of one or more criteria is met. In some embodiments, the background of the portion of the first user interface has a third appearance in accordance with a determination that the second set of one or more criteria is met. In some embodiments, the third appearance is different from the first appearance.

In some embodiments, the first set of one or more criteria includes a criterion that is met when a determination is made that the respective area is associated with a first type of device (e.g., a particular phone, screen, display, fitness tracking device, wearable device, and/or a device that is associated with only a portion of the compute system and/or a local device and/or portion of the computer system). In some embodiments, in response to detecting the change in the coupling status of the computer system and in accordance with a determination that the computer system is currently magnetically coupled to a second respective area, wherein the second respective area is associated with a second type of device (e.g., a particular phone, screen, display, fitness tracking device, wearable device, and/or a device that is associated with only a portion of the compute system and/or a global device and/or portion of the computer system) that is different from the first type of device (and, in some embodiments, the second respective area is not associated with the first type of device), the computer system forgoes displaying the first set of one or more controls. In some embodiments, in response to detecting the change in the coupling status of the computer system and in accordance with a determination that the computer system is currently magnetically coupled to the second respective area, the computer system displays the second set of one or more controls. In some embodiments, in response to detecting the change in the coupling status of the computer system and in accordance with a determination that the computer system is currently magnetically coupled to the second respective area, the computer system does not display the second set of one or more controls. Selectively displaying the first set of one or more controls in accordance with a determination that a respective area is associated with a first type of device and not a second type of device allows the first set of controls to be displayed when they are relevant to a device associated with an area in which the computer system is magnetically coupled, thereby reducing the number of inputs needed to perform an operation, providing additional control options without cluttering the user interface with additional displayed controls, and/or performing an operation when a set of conditions has been met without requiring further user input.

In some embodiments, while displaying the first user interface that includes the first set of one or more controls (and, in some embodiments, in response to detecting the change to the coupling status of the computer system and in accordance with a determination that a first set of one or more criteria is met), the computer system displays, via the display component, a first set of indications (e.g., textual, symbolic, visual, and/or graphic indications, representations, and/or user interface objects) corresponding to one or more settings related to the respective area (and, in some embodiments, not related to a different respective area) (e.g., as described above with respect to FIGS. 2B and/or 2C). In some embodiments, while displaying the second user interface that includes the second set of one or more controls, the computer system does not display a set of indications corresponding to one or more settings related to the respective area (and, in some embodiments, any respective and/or particular area). Displaying the first set of indicators corresponding to one or more settings related to the respective area while displaying the first set of one or more controls allows for a user to identify information about settings relevant to a current situation and/or location in which the computer system is magnetically coupled, thereby reducing the number of inputs needed to perform an operation, providing additional control options without cluttering the user interface with additional displayed controls, and/or performing an operation when a set of conditions has been met without requiring further user input.

In some embodiments, in response to detecting the change to the coupling status of the computer system and in accordance with a determination that the computer system is currently magnetically connected to a third respective area (e.g., a left side as opposed to a right side of a computer system) that is different from the respective area, the computer system displays, via the display component, a third set of one or more controls (e.g., 612 or 636) that is different from the first set of one or more controls (e.g., without displaying the first set of one or more controls). In some embodiments, the third set of one or more controls is not displayed in accordance with a determination that a first set of one or more criteria is met and/or when the first set of one or more controls is displayed. In some embodiments, the third set of one or more controls is related to the third respective area and not related to the respective area. In some embodiments, the first set of one or more controls are not related to the third respective area but is related to the first respective area. In some embodiments, in response to detecting selection of one or more controls, a user interface is displayed that includes settings that corresponds to the selected control. In some embodiments, in response to detecting an input (e.g., a tap input and/or a non-tap input (e.g., a gaze input, an air gesture, a pointing gesture a swipe input, and/or a mouse click)) directed to a setting of the selected control, the computer system causes output of a device (e.g., a fan, a thermostat, a window, a door, and/or a light) to change. Displaying the third set of one or more controls in accordance with a determination that the computer system is currently magnetically coupled to the third respective area allows the third set of controls to be displayed when they are relevant to an area in which the computer system is magnetically coupled, thereby reducing the number of inputs needed to perform an operation, providing additional control options without cluttering the user interface with additional displayed controls, and/or performing an operation when a set of conditions has been met without requiring further user input.

In some embodiments, in response to detecting the change to the coupling status of the computer system, the computer system transitions the display component from a first state (e.g., an off state, a sleep state, an inactive state, a hibernate state, and/or a reduced power state) to a second state (e.g., an on state, an awake state, and/or an increased power state) that is different from the first state. In some embodiments, in response to detecting the change to the coupling status of the computer system, the computer system is not transitioned to a different state and/or continues to be in an on state, an awake state, and/or an increased power state. Transitioning the display component from the first state to the second state in response to detecting the change to the coupling status of the computer system allows for the display component to be in a state that is consistent with the coupling status without the user needing to manually change the state, thereby reducing the number of inputs needed to perform an operation and/or performing an operation when a set of conditions has been met without requiring further user input.

In some embodiments, the first set of one or more controls are (and/or or includes at least one) local controls that are directed to (e.g., directly impact, configured to impact, configured to be controlled by a user associated with, and/or configured to adjust output of) one or more devices (e.g., a thermostat, a fan, a seat, a window, a door, and/or a light) associated with the respective area and not a fourth respective area that is different from the respective area. In some embodiments, the second set of one or more controls are (and/or or includes at least one) global controls that are directed to (e.g., directly impact, configured to impact, configured to be controlled by a user associated with, and/or configured to adjust output of) one or more devices (e.g., one or more thermostats, fans, seats, windows, doors, and/or lights) associated with the respective area and the fourth respective area. The first set of one or more controls being local controls and the second set of controls being global controls allows for the set of one or more controls that is displayed to be relevant to a current situation and/or location in which the computer system is located, thereby reducing the number of inputs needed to perform an operation, providing additional control options without cluttering the user interface with additional displayed controls, and/or performing an operation when a set of conditions has been met without requiring further user input.

In some embodiments, the first set of one or more controls do not include and the second set of one or more controls includes a control (e.g., 628b) that, when selected, causes output of media (e.g., audio and/or video media) to be adjusted (e.g., pauses, plays, stops, reverses, fast-forwards, rewinds, skips forward to new, and/or skips backwards to previous media) (e.g., by a speaker, a display, and/or a television). The second set of one or more controls including a control related to media while the first set of one or more controls not including such a control allows for the set of one or more controls that is displayed to be relevant to a current situation and/or location in which the computer system is located, thereby reducing the number of inputs needed to perform an operation, providing additional control options without cluttering the user interface with additional displayed controls, and/or performing an operation when a set of conditions has been met without requiring further user input.

In some embodiments, the first set of one or more controls includes and the second set of one or more controls do not include a control, that when selected, causes output of a device (e.g., a fan, a thermostat, a door, a light, and/or a window) that impacts (e.g., affects and/or causes to change) temperature of the environment to be adjusted. The first set of one or more controls including a control that impacts temperature while the second set of one or more controls not including such a control allows for the set of one or more controls that is displayed to be relevant to a current situation and/or location in which the computer system is located, thereby reducing the number of inputs needed to perform an operation, providing additional control options without cluttering the user interface with additional displayed controls, and/or performing an operation when a set of conditions has been met without requiring further user input.

In some embodiments, while displaying the second set of one or more controls, the computer system detects an input (e.g., a tap input and/or a non-tap input (e.g., a gaze input, an air gesture, a pointing gesture a swipe input, and/or a mouse click)) directed to one control in the second set of one or more controls. In some embodiments, in response to detecting the input directed to the one control in the second set of one or more controls, the computer system displays, via the display component, an indication (e.g., textual, symbolic, visual, and/or graphic indication, representation, and/or user interface object) that a value has been adjusted. Displaying the indication that the value has been adjusted in response to detecting the input directed to the one control in the second set of one or more controls allows for the user to identify a state of the value as the user causes it to change, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, while displaying the first set of one or more controls, the computer system detects an input (e.g., a tap input and/or a non-tap input (e.g., a gaze input, an air gesture, a pointing gesture a swipe input, and/or a mouse click)) directed to one control in the first set of one or more controls. In some embodiments, in response to detecting the input directed to the one control in the first set of one or more controls, the computer system forgoes displaying, via the display component, an indication (e.g., textual, symbolic, visual, and/or graphic indication, representation, and/or user interface object) that a value has been adjusted.

In some embodiments, while displaying the first set of one or more controls, the computer system detects a set of one or more inputs that includes an input (e.g., a tap input and/or a non-tap input (e.g., a gaze input, an air gesture, a pointing gesture a swipe input, and/or a mouse click)) directed to a respective control in the first set of one or more controls. In some embodiments, in response to detecting the set of one or more inputs (and, in some embodiments, in response to detecting the respective control in the first set of one or more controls), the computer system causes output of a device associated with the respective area (and not associated with another respective area) to change. Causing output of the device associated with the respective area to change in response to detecting the set of one or more inputs including the input directed to the respective control allows for a user to control output of devices in a region related to where the computer system is magnetically coupled, thereby reducing the number of inputs needed to perform an operation, providing additional control options without cluttering the user interface with additional displayed controls, and/or performing an operation when a set of conditions has been met without requiring further user input.

In some embodiments, the second set of one or more controls consists of a first number of controls. In some embodiments, the first set of one or more controls consists of a second number of controls that is different from the first number of controls. In some embodiments, the first number is greater than the second number or the first number is less than the second number. The first set of one or more controls consisting of a different number of controls than the second set of one or more controls allows for the set of one or more controls that is displayed to be relevant and/or catered to whether the computer system is currently magnetically coupled, thereby reducing the number of inputs needed to perform an operation, providing additional control options without cluttering the user interface with additional displayed controls, and/or performing an operation when a set of conditions has been met without requiring further user input.

In some embodiments, the second set of one or more controls includes a control (e.g., 628b) that is included in the first set of one or more controls. In some embodiments, the first set of controls and second set of controls include at least one control that is the same. The second set of one or more controls including a control that is included in the first set of one or more controls allows for controls that are relevant to both contexts to be displayed, thereby reducing the number of inputs needed to perform an operation, providing additional control options without cluttering the user interface with additional displayed controls, and/or performing an operation when a set of conditions has been met without requiring further user input.

In some embodiments, the first set of one or more controls includes at least one control that is not included in the second set of one or more controls. In some embodiments, the second set of one or more controls includes at least one control that is not included in the first set of one or more controls. In some embodiments, the first set of one or more controls and the second set of one or more controls do not include at least one control that is the same. The first set of one or more controls including a control that is not included in the second set of one or more controls allows for controls that are relevant when the computer system is currently magnetically coupled to be displayed when the computer system is currently magnetically coupled and not when the computer system is not currently magnetically coupled, thereby reducing the number of inputs needed to perform an operation, providing additional control options without cluttering the user interface with additional displayed controls, and/or performing an operation when a set of conditions has been met without requiring further user input.

In some embodiments, each control in the first set of one or more controls is different from each control in the second set of one or more controls. In some embodiments, each control in the second set of one or more controls is different from each control in the first set of one or more controls. In some embodiments, the first set of one or more controls and second set of one or more controls include none of the same controls. Having each control in the first set of one or more controls be different than each control in the second set of one or more controls allows for controls that are relevant when the computer system is currently magnetically coupled to be displayed when the computer system is currently magnetically coupled and not when the computer system is not currently magnetically coupled, thereby reducing the number of inputs needed to perform an operation, providing additional control options without cluttering the user interface with additional displayed controls, and/or performing an operation when a set of conditions has been met without requiring further user input.

Note that details of the processes described above with respect to process 700 (e.g., FIG. 3) are also applicable in an analogous manner to other methods described herein. For example, process 800 optionally includes one or more of the characteristics of the various methods described above with reference to process 700. For example, the first set of controls of process 700 can be included in the first content of process 800. For brevity, these details are not repeated below.

FIG. 4 is a flow diagram illustrating a method (e.g., process 800) for providing an indication of a state of a computer system in accordance with some embodiments. Some operations in process 800 are, optionally, combined, the orders of some operations are, optionally, changed, and some operations are, optionally, omitted.

As described below, process 800 provides an intuitive way for providing an indication of a state of a computer system. Process 800 reduces the cognitive burden on a user for identifying a state of a computer system, thereby creating a more efficient human-machine interface. For battery-operated computing devices, enabling a user to identify a state of a computer system faster and more efficiently conserves power and increases the time between battery charges.

In some embodiments, process 800 is performed at a computer system (e.g., 100 and/or 600) that is in communication with a display component (e.g., 604) (e.g., a display screen and/or a touch-sensitive display). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

The computer system displays (802), via the display component, a first user interface (e.g., 606) that includes first content (e.g., 606 and/or 628) and a first plurality of selection indicators (e.g., 610 as illustrated in FIG. 2A) (e.g., paging dots and/or text indicators that includes a value (e.g., 1, 2, 3, 4; I, II, III, IV, and/or V) associated with particular content), the first plurality of selection indicators including a selection indicator (e.g., 610a as illustrated in FIG. 2A) that indicates that the first content (e.g., text, one or more user interface objects, and/or one or more videos, images, and/or symbols) is selected (e.g., bolding, a focus indicator, highlighting, emphasizing (e.g., enlarged indicator compared to other indicators), and/or textual indicator) (and, in some embodiments, a selection indicator that indicates that second content is not selected).

While displaying, via the display component, the first user interface that includes the first content and the first plurality of selection indicators and the selection indicator that indicates that the first content (e.g., at a respective position/area, a main position/area, and/or a central position/area of the display) is selected, the computer system detects (804) a change to a coupling status (e.g., a magnetic coupling status, a wireless coupling status, and/or a wired coupling status) of the computer system (e.g., as described above with respect to FIGS. 2B and/or 2C).

In response to (806) detecting the change to the coupling status of the computer system (and, in some embodiments, while displaying, via the display component, a first user interface and/or and in response to detecting presence (e.g., detecting that a user and/or device associated with the user is within a predetermined distance (e.g., 1-5 meters) from the computer system) of a user), the computer system ceases (808) display of the selection indicator that indicates that the first content is selected (e.g., 610a as illustrated in FIG. 2B or 2C).

In response to (806) detecting the change to the coupling status of the computer system, the computer system displays (810), via the display component, a second user interface (e.g., 618 and/or 638) that includes second content (e.g., 612 and/or 636) (and, in some embodiments, does not include the first content) (e.g., at a respective position/area, a main position/area, and/or a central position/area of the display) and a second plurality of selection indicators (e.g., 610 as illustrated in FIGS. 2B-2C), the second plurality of selection indicators including a selection indicator (e.g., 610b or 610c as illustrated in FIGS. 2B-2C) that indicates that the second content is selected (and, in some embodiments, a selection indicator that indicates that the first content is not selected), wherein the second content is different from the first content. In some embodiments, the selection indicator that indicates that the first content is selected is at a first position relative to the first user interface, the selection indicator that indicates that the second content is selected is at a second position relative to the second user interface, where the second position is different from the first position. Displaying the second content and the selection indicator that indicates that the second content is selected in response to detecting the change to the coupling status of the computer system allows for content to be presented to the user that is relevant to a current coupling status of the computer system, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, the first content includes a first set of one or more controls (e.g., as described above in relation to process 700) (e.g., 628). In some embodiments, the second content includes a second set of one or more controls (e.g., as described above in relation to process 700) (e.g., 612 or 636) that is different from the first set of one or more controls. The different content including different sets of one or more controls allows for the set of one or more controls that is displayed to be relevant to a current situation and/or location in which the computer system is magnetically coupled, thereby reducing the number of inputs needed to perform an operation, providing additional control options without cluttering the user interface with additional displayed controls, and/or performing an operation when a set of conditions has been met without requiring further user input.

In some embodiments, the second plurality of selection indicators includes an indicator (e.g., 610a in FIG. 2B or 2C) that indicates that the first content is not selected (e.g., not bolded, emphasized, enlarged, and/or not in focus when compared to another indicator). In some embodiments, the first plurality of selection indicators includes an indicator that indicates that the second content is not selected. In some embodiments, while the indicator that indicates that the first content is not selected is displayed, the indicator that indicates that the first content is not selected is displayed at the same position as the indicator that indicates that the first content is selected is displayed, while the indicator that indicates that the first content is selected is displayed. In some embodiments, while the indicator that indicates that the second content is not selected is displayed, the indicator that indicates that the second content is not selected is displayed at the same position as the indicator that indicates that the second content is selected is displayed, while the indicator that indicates that the second content is selected is displayed. The second plurality of selection indicators including the indicator that indicates that the first content is not selected allows for a user to identify which portion of content is being displayed at a glance and what types of input would display which other portion of content, thereby providing improved visual feedback to the user, reducing the number of inputs needed to perform an operation, and/or performing an operation when a set of conditions has been met without requiring further user input.

In some embodiments, in response to detecting the change to the coupling status of the computer system, the computer system ceases display of the first content (e.g., as illustrated in FIG. 2B or 2C). In some embodiments, the second user interface does not include the first content. In some embodiments, the first user interface does not include the second content. Ceasing display of the first content in response to detecting the change to the coupling status of the computer system allows for content that is displayed to be relevant to a current coupling status, thereby providing improved visual feedback to the user, reducing the number of inputs needed to perform an operation, and/or performing an operation when a set of conditions has been met without requiring further user input.

In some embodiments, the first content is displayed at a respective position (e.g., a position and/or location on a display and/or a user interface that is displayed on the display) (e.g., where 606 is located) before detecting the change to the coupling status of the computer system. In some embodiments, the second content is displayed at the respective position in response to detecting the change to the coupling status of the computer system. Displaying the first content and the second content at the respective portion allows the content to be in a consistent position for a user to quickly know where to look, thereby providing improved visual feedback to the user and/or performing an operation when a set of conditions has been met without requiring further user input.

In some embodiments, displaying the second user interface that includes the second content includes replacing (e.g., via a transition animation, such as a dissolving, fading, and/or sliding animation) the first user interface that includes the first content with the second user interface that includes the second content (e.g., as described above with respect to FIGS. 2B-2C). Replacing the first user interface with the second user interface (e.g., via a transition animation) allows the computer system to transition between what is being displayed while identifying what content is being displayed, thereby providing improved visual feedback to the user and/or performing an operation when a set of conditions has been met without requiring further user input.

In some embodiments, displaying the second user interface that includes the second content includes scrolling (e.g., in the direction that corresponds to a direction defined by movement from the position of the first selection indicator to the second selection indicator) the first user interface that includes the first content to display the second user interface that includes the second content. Scrolling the first user interface to display the second user interface allows a user to intuitively switch between user interfaces in a manner that the user is used to with other user interfaces while, in some embodiments, not requiring additional user-interface elements for switching, thereby providing improved visual feedback to the user, reducing the number of inputs needed to perform an operation, and/or performing an operation when a set of conditions has been met without requiring further user input.

In some embodiments, detecting the change in the coupling status of the computer system includes detecting that the computer system is in a mounted state (e.g., is magnetically coupled to a device and/or an area). In some embodiments, while the computer system is in the mounted state, the computer system is being changed. Detecting that the computer system is in a mounted state to cause different content to be displayed allows the computer system to cater what is being displayed based on the mounted state and/or reduce the amount of content displayed in a state for which the content is not as relevant, thereby providing improved visual feedback to the user, reducing the number of inputs needed to perform an operation, and/or performing an operation when a set of conditions has been met without requiring further user input.

In some embodiments, the second content includes one or more global controls. In some embodiments, in response to detecting selection of the global control, a user interface for setting a device that is associated with all portions and/or the entirety of the computer system is displayed. In some embodiments, a global control of the one or more global controls is configured to modify a setting that affects and/or impacts a first respective area and a second respective area. In some embodiments, a local control is configured to modify a setting that affects and/or impacts the first respective area or the second respective area. The second content including one or more global controls allows for a user to switch contexts (e.g., interact with different content, that might not be applicable to an area local to where the computer system is magnetically coupled) when detecting the change to the coupling status of the computer system, thereby providing improved visual feedback to the user, reducing the number of inputs needed to perform an operation, and/or performing an operation when a set of conditions has been met without requiring further user input.

In some embodiments, detecting the change in the coupling status of the computer system includes detecting that the computer system is in an unmounted state (e.g., is not magnetically coupled to a device and/or an area). Detecting that the computer system is in an unmounted state to cause different content to be displayed allows the computer system to cater what is being displayed based on the mounted state and/or reduce the amount of content displayed in a state for which the content is not as relevant, thereby providing improved visual feedback to the user, reducing the number of inputs needed to perform an operation, and/or performing an operation when a set of conditions has been met without requiring further user input.

In some embodiments, the second content includes one or more local controls. In some embodiments, in response to detecting selection of the global control, a user interface for setting a device that is associated with less than all portions and/or less than the entirety of the computer system is displayed. In some embodiments, a local control of the one or more local controls is configured to modify a setting that affects a first respective area or a second respective area. In some embodiments, a global control is configured to modify a setting that affects the first respective area and the second respective area. The second content including one or more local controls allows for a user to switch contexts (e.g., interact with different content, that might not be applicable to an area local to where the computer system is magnetically coupled and/or continue to interact with content that is applicable to the area) when detecting the change to the coupling status of the computer system, thereby providing improved visual feedback to the user, reducing the number of inputs needed to perform an operation, and/or performing an operation when a set of conditions has been met without requiring further user input.

In some embodiments, detecting the change in the coupling status of the computer system includes detecting that the computer system is magnetically coupled to an area (e.g., 600b) (an object and/or a particular magnetic coupling device) (e.g., as described in relation to process 700). Detecting that the computer system is magnetically couple to the area to cause different content to be displayed allows the computer system to cater what is being displayed based on the area and/or reduce the amount of content displayed in a state for which the content is not as relevant, thereby providing improved visual feedback to the user, reducing the number of inputs needed to perform an operation, and/or performing an operation when a set of conditions has been met without requiring further user input.

In some embodiments, detecting the change in the coupling status of the computer system includes detecting that the computer system is coupled to a respective device (e.g., 630 and/or 632) via a wired (e.g., via a dongle and/or cord) or wireless connection (e.g., via a Bluetooth, internet, and/or NFC connection). Detecting that the computer system is coupled to a respective device via a wired or wireless connection to cause different content to be displayed allows the computer system to cater what is being displayed based on communication being enabled and/or to reduce the amount of content displayed in a state for which the content is not as relevant, thereby providing improved visual feedback to the user, reducing the number of inputs needed to perform an operation, and/or performing an operation when a set of conditions has been met without requiring further user input.

In some embodiments, while displaying the second user interface that includes the second content and the second plurality of selection indicators, the computer system detects an input (e.g., a swipe input and/or a non-swipe input (e.g., a gaze input, an air gesture, a swiping gesture a tap input, and/or a mouse click and drag input)) with a first directional component. In some embodiments, in response to detecting the input with the first directional component (e.g., a first direction in the x, y, and/or z plane), the computer system ceases display of the second user interface that includes the second content and the second plurality of selection indicators. In some embodiments, in response to detecting the input with the first directional component, the computer system displays (e.g., re-displays and/or displays again), via the display component, the first user interface that includes the first content and the first plurality of selection indicators. Displaying the first user interface after previously displaying the first user interface in response to detecting the input with the first directional component allows a user to easily and quickly switch between what content is viewed, particularly when the computer system changes the content intelligently based on a change in the coupling status of the computer system, thereby reducing the number of inputs needed to perform an operation and/or performing an operation when a set of conditions has been met without requiring further user input.

In some embodiments, while displaying the second user interface that includes the second content and the second plurality of selection indicators, the computer system detects an input (e.g., a swipe input and/or a non-swipe input (e.g., a gaze input, an air gesture, a swiping gesture a tap input, and/or a mouse click and drag input)) with a second directional component that is different from (e.g., opposite of and in an opposing direction) the first directional component. In some embodiments, in response to detecting the input with the second directional component: (e.g., a first direction in the x, y, and/or z plane), the computer system ceases display of the second user interface that includes the second content and the second plurality of selection indicators. In some embodiments, in response to detecting the input with the second directional component, the computer system displays, via the display component a third user interface that includes third content and a third plurality of selection indicators, the third plurality of selection indicators including a selection indicator that indicates that the third content is selected, wherein the third content is different from the first content and the second content. In some embodiments, the third plurality of selection indicators includes a selection indicator that indicates that the first content is not selected and/or a selection indicator that indicates that the second content is not selected. Displaying the third user interface in response to detecting the input with the second directional component allows the user to switch between what content is displayed by providing inputs with different directional components (e.g., and no additional user interface elements), thereby reducing the number of inputs needed to perform an operation and/or performing an operation when a set of conditions has been met without requiring further user input.

Note that details of the processes described above with respect to process 800 (e.g., FIG. 4) are also applicable in an analogous manner to other methods described herein. For example, process 700 optionally includes one or more of the characteristics of the various methods described above with reference to process 800. For example, the second content of process 800 can include the second set of one or more controls of process 700. For brevity, these details are not repeated.

FIGS. 5A-5C illustrate exemplary user interfaces for locating objects in accordance with some embodiments. The user interfaces in these figures are used to illustrate the processes described below, including the processes in FIG. 6.

FIG. 5A illustrates computer system 600. As illustrated in FIG. 5A, computer system 600 displays external device user interface 902. External device user interface 902 includes first light control user interface object 912, second light control user interface object 914, first window control user interface object 916, second window control user interface object 918, and remote-control locator user interface object 920. Each of first light control user interface object 912, second light control user interface object 914, first window control user interface object 916, and second window control user interface object 918 correspond to a respective external device (e.g., a device that is external to computer system 600). Remote-control locator user interface object 920 corresponds to an electronic remote-control device that is used to control one or more external devices and/or computer system 600.

At FIG. 5A, computer system 600 detects input 905a that corresponds to selection of remote-control locator user interface object 920. In some embodiments, input 905a corresponds to a tap input, a swipe input, a gaze, a voice command, a long press (e.g., a press and hold), and/or a hand gesture. In some embodiments, the remote-control device is a smart phone, a smart watch, a smart speaker, a fitness tracking device, a playback device remote, and/or a television remote. In some embodiments, computer system 600 and the remote-control device are in wireless communication (e.g., Wi-Fi, Bluetooth, and/or Ultrawideband). In some embodiments, the remote-control device is used to control the external devices that correspond to one or more of first light control user interface object 912, second light control user interface object 914, first window control user interface object 916, and/or second window control user interface object 918. In some embodiments, in response to detecting an input that corresponds to selection of one of first light control user interface object 912, second light control user interface object 914, first window control user interface object 916, and/or second window control user interface object 918, computer system 600 transmits instructions to the corresponding external device that cause a status of the corresponding external device to the change (e.g., the instructions cause the brightness of a light to increase or decrease or the instructions cause a window to open or close). In some embodiments, in accordance with a determination that the remote-control device is mounted (e.g., the remote-control device is magnetically coupled to an external charger (e.g., as described above in reference to FIGS. 2B-2C) and/or the remote-control device is coupled to a charger via a wired connection), computer system 600 does not display remote-control locator user interface object 920. In some embodiments, computer system 600 displays remote-control locator user interface object 920 as un-selectable (e.g., computer system 600 displays remote-control user interface object 920 as greyed out) while the remote-control device is mounted. In some embodiments, computer system 600 displays external device user interface 902 in response to detecting that computer system 600 is coupled to an external charger (e.g., as described above in references to FIGS. 2B and 2C).

FIGS. 5B and 5C illustrate different scenarios of the behavior of both computer system 600 and external devices in response to computer system 600 detecting input 905a. More specifically, FIG. 5B illustrates a first scenario where computer system 600 detects input 905a while remote-control device is positioned between a first light device and a television and FIG. 5C illustrates a second scenario where computer system 600 detects input 905a while the remote-control device is positioned between a second light device and the television. Either FIG. 5B or FIG. 5C can follow FIG. 5A.

At FIG. 5B, in response to detecting input 905a, computer system 600 ceases to display external device user interface 902 and displays physical environment schematic user interface 930. Physical environment schematic user interface 930 is a representation of a physical environment (e.g., a room in a house, an office building, a car, and/or an airplane) that corresponds to the location of the remote-control device. As illustrated in FIG. 5B, physical environment schematic user interface 930 includes first light device user interface object 922, second light device user interface object 924, first playback device user interface object 926, second playback device user interface object 928, television user interface object 936, and remote-control user interface object 932. First light device user interface object 922 represents a first light device (e.g., a lamp, ceiling light, and/or lights incorporated into a fan) that is located in the physical environment, second light device user interface object 924 represents a second light device (e.g., a lamp, ceiling light, and/or lights incorporated into a fan) that is located in the physical environment, first playback device user interface object 926 represents a first playback device (e.g., a smart speaker, subwoofer, and/or radio) that is located in the physical environment, second playback device user interface object 928 represents a second playback device in the physical environment, television user interface object 936 represents a television device that is located in the physical environment, and remote-control user interface object 932 represents the remote-control device.

At FIG. 5B, a determination is made that the remote-control device (e.g., the remote-control device that remote-control user interface object 932 represents) is positioned between the first light device and the television within the physical environment. Because a determination is made that the remote-control device is positioned between the first light device and the television, computer system 600 displays remote-control user interface object 932 between first light device user interface object 922 and television user interface object 936. That is, computer system 600 displays remote-control user interface object 932 within physical environment schematic user interface 930 based on the real-world location of the remote-control device within the physical environment relative to other devices in the physical environment. In some embodiments, the display of remote-control user interface object 932 within physical environment schematic user interface 930 is dynamic (e.g., computer system 600 changes, in real time, the location of the display of remote-control user interface object 932 within physical environment schematic user interface 930 based on changes to the real-world location of the remote-control device). In some embodiments, computer system 600 ceases to display remote-control user interface object 932 in accordance with a determination that a user possess the remote-control device. In some embodiments, computer system 600 ceases to display remote-control user interface object 932 in accordance with a determination that the remote-control device transitions from being unmounted to mounted to an external charger (e.g., as described above in relation to FIGS. 2B-2C).

Further, at FIG. 5B, a determination is made that the remote-control device is within a predetermined distance (e.g., 0.5, 1, 3, 5, 7, 10, 15, or 20 feet) from the first light device and the television. At FIG. 5B, because a determination is made that the remote-control device is within the predetermined distance from the first light device and the television, the first light device outputs an alert (e.g., flashes a light and/or transitions from being powered off to being powered on) and the television outputs an alert (e.g., flashes the display of the television and/or outputs an audio alert). That is, in response to computer system 600 detecting an input that corresponds to selection of remote-control locator user interface object 920, one or more external devices that are within the predetermined distance from the remote-control device output an alert (e.g., output a sound, display a video, and/or turn on lights) that indicates to the user the location of the remote-control device. At FIG. 5B, second light device, first playback device, and second playback device do not output an alert because the second light device, the first playback device, and the second playback device are not within the predetermined distance from the remote-control device. In some embodiments, the first light device and/or the television device output a targeted alert that is based on the location of the remote-control device relative to the first light device and/or the television (e.g., the first light device and/or the television outputs an alert in the direction of the remote-control device (e.g., if the remote-control device is positioned to the left of the television, the television will output an audio alert using a set of speakers that are positioned on the left side of the television and/or if the remote-control device is positioned to the right of the first light device, the first light device will output a visual alert using a set of light bulbs are the positioned on the right side of the first light device)). In some embodiments, the first light device and the television will cease to output the alerts in response to computer system 600 ceasing to display physical environment schematic user interface 930. In some embodiments, in accordance with a determination that the remote-control device is mounted, the first light device and the television do not output a respective alert in response to computer system 600 detecting an input that corresponds to selection of remote-control locator user interface object 920. In some embodiments, in accordance with a determination that the remote-control device is not mounted and in accordance with a determination that the remote-control device is within the predetermined threshold distance of both the television and the first light device, the television and the first light device output the alert in response to computer system 600 detecting an input that corresponds to selection of remote-control locator user interface object 920.

Computer system 600 indicates which external devices output an alert within physical environment schematic user interface 930. As illustrated in FIG. 5B, because the first light device outputs an alert, computer system 600 displays first light device user interface object 922 with a filled in appearance (e.g., in comparison to second light device user interface object 924 that is not filled in) to indicate that the first light device outputs an alert. Further, as illustrated in FIG. 5B, because the television outputs an alert, computer system 600 displays soundwaves as emanating from television user interface object 936 to indicate that the television outputs an alert. In some embodiments, because the first light device and the television are different types of devices, the first light device outputs a first type of alert (e.g., a visual alert) and the television outputs a second type of alert (e.g., a visual and/or audio alert) that is different than the first type of alert. In some embodiments, the external devices output an alert for a predetermined period of time (e.g., 5, 10, 15, 25, 50, 120, or 180 seconds). In some embodiments, the external devices output a visual alert (e.g., a flashing light). In some embodiments, the external devices output an audio alert (e.g., a sound that repeats itself). In some embodiments, the external devices output a combination of a visual alert and an audio alert. In some embodiments, the external devices cease to output the alert in accordance with a determination that a user is in possession of the remote-control device. In some embodiments, the remote-control device outputs an alert (e.g., an audio alert, tactile alert, and/or a visual alert) in response to computer system 600 detecting an input that corresponds to selection of remote-control locator user interface object 920. In some embodiments, the alert is comprised of one continuous sound. In some embodiments, the alert is comprised of a number of discrete sounds.

As explained above, FIG. 5C illustrates a scenario where computer system 600 detects input 905a while the remote-control device is positioned between a second light device and the television. Either FIG. 5B or FIG. 5C can follow FIG. 5A.

At FIG. 5C, in response to detecting input 905a, computer system 600 ceases to display external device user interface 902 and displays physical environment schematic user interface 930. At FIG. 5C, a determination is made that the remote-control device (e.g., the remote-control device that remote-control locator user interface object 920 represents) is positioned between the second light device and the television within the physical environment. As explained above, computer system 600 displays remote-control user interface object 932 within physical environment schematic user interface 930 based on the real-world location of the remote-control device within the physical environment relative to other devices in the physical environment. Accordingly, as illustrated in FIG. 5C, because a determination is made that the remote-control device is positioned between the second light device and the television, computer system 600 displays remote-control user interface object 932 between second light device user interface object 924 and television user interface object 936.

Further, at FIG. 5C, a determination is made that the remote-control device is within the predetermined distance of the second light device, the first playback device and the television. As explained above, in response to computer system 600 detecting an input that corresponds to selection of remote-control locator user interface object 920, one or more external devices that are within the predetermined distance from the remote-control device output an alert (e.g., output a sound, display a video, turn on lights) that indicates to the user the location of the remote-control device. Accordingly, at FIG. 5C, because a determination is made that the remote-control device is within the predetermined distance of the second light device, the first playback device, and the television, the second light device outputs an alert (e.g., flashes a light), the first playback device outputs an alert (e.g., an audio alert) and the television outputs an alert (e.g., flashes the display of the television and/or outputs an audio alert). At FIG. 5C, the first light device and the second playback device do not output a respective alert because the first light device and the second playback device are not within the predetermined distance from the remote-control device. As illustrated in FIG. 5C, because the second light device outputs an alert, computer system 600 displays second light device user interface object 924 with a filled in appearance (e.g., in comparison to first light device user interface object 922 that is not filled in) to indicate that the second light device outputs an alert. Further, as illustrated in FIG. 5C, because the television and the first playback device output an alert, computer system 600 displays soundwaves as emanating from television user interface object 936 and first playback device user interface object 926 to indicate that the first playback device and the television both output an alert.

FIG. 6 is a flow diagram illustrating a method (e.g., process 1000) for locating objects in accordance with some embodiments. Some operations in process 1000 are, optionally, combined, the orders of some operations are, optionally, changed, and some operations are, optionally, omitted.

As described below, process 1000 provides an intuitive way for locating objects. Process 1000 reduces the cognitive burden on a user for locating objects, thereby creating a more efficient human-machine interface. For battery-operated computing devices, enabling a user to locate objects faster and more efficiently conserves power and increases the time between battery charges.

In some embodiments, process 1000 is performed at a computer system (e.g., 100 and/or 600) that is in communication with a display component (e.g., a display screen and/or a touch-sensitive display), a first set of one or more devices (e.g., a light, a speaker, a phone, a tablet, a processor, a head-mounted display (HMD) device, and/or a personal computing device) (e.g., 922, 924, 926, 928, and/or 936) that does not include an object (e.g., a device and/or a remote control) (e.g., 932), a second set of one or more devices (e.g., a light, a speaker, a phone, a tablet, a processor, a head-mounted display (HMD) device, and/or a personal computing device) (e.g., 922, 924, 926, 928, and/or 936) that does not include the object, and one or more input devices (e.g., a physical input mechanism, a camera, a touch-sensitive display, a microphone, and/or a button). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

The computer system detects (1002), via the one or more input devices, a request (e.g., 905a) to identify (e.g., find, search for, and/or highlight) a location of the object.

In response to (1004) detecting the request to identify the location of the object, in accordance with a determination that the first set of one or more devices meets a respective set of one or more criteria (e.g., that includes a criterion that is met when the first set of one or more devices is within a predetermined distance (e.g., 0.1-40 meters) from the object and/or that includes a criterion that is met when the first set of one or more devices is designed for (e.g., targeted at a particular area (e.g., a particular area that includes the object))) and the second set of one or more devices does not meet the respective set of one or more criteria (e.g., that includes a criterion that is met when the second set of one or more devices is within a predetermined distance (e.g., 0.1-40 meters) from the object and/or that includes a criterion that is met when the second set of one or more devices is designed for (e.g., targeted at a particular area (e.g., a particular area that includes the object))), the computer system causes (1006) the first set of one or more devices (e.g., 922, as described with respect to FIG. 5B) to provide output indicating the position of the object in an environment without causing the second set of one or more devices (e.g., 924 and 926) to provide output indicating the position of the object in the environment.

In response to (1004) detecting the request to identify the location of the object, in accordance with a determination that the first set of one or more devices does not meet the respective set of one or more criteria and the second set of one or more meets the respective set of one or more criteria, the computer system causes (1008) the second set of one or more devices (e.g., 924 and 926, as described with respect to FIG. 5C) to provide output indicating the position of the object in the environment without causing the first set of one or more devices (e.g., 922) to provide output indicating the position of the object in the environment. In some embodiments, in accordance with a determination that the first set of one or more devices and the second set of one or more meet the one or more respective set of criteria, the computer system causes the first set of one or more devices and the second set of one or more devices to provide output indicating the position of the object in the environment. In some embodiments, in accordance with a determination that the first set of one or more devices and the second set of one or more does not meet the one or more respective set of criteria, the computer system does not cause the first set of one or more devices and the second set of one or more devices to provide output indicating the position of the object in the environment. Causing different set of one or more devices to provide output indicating the position of the object in the environment allows a user to better and/or more easily locate the object using devices in the environment, thereby providing improved visual feedback to the user and/or performing an operation when a set of conditions has been met without requiring further user input.

In some embodiments, the object is an electronic device (e.g., a remote control, a phone, a computer system, a wearable device, a tablet, a fitness tracking device, and/or a controller that controls one or more external devices to the controller). The object being an electronic device allows for the computer system and/or the user to better and/or more easily locate the object due to communications and/or output by the electronic device, thereby providing improved visual feedback to the user and/or performing an operation when a set of conditions has been met without requiring further user input.

In some embodiments, in response to detecting the request to identify the location of the object (e.g., find the object, search for the object, and/or locate the object), the computer system causes the electronic device to provide output (e.g., haptic output, light output (e.g., a beam and/or ray of light) and/or sound output). Causing the electronic device to provide output in response to detecting the request to identify the location of the object allows for the user to better and/or more easily locate the object due to the output by the electronic device, thereby providing improved visual feedback to the user and/or performing an operation when a set of conditions has been met without requiring further user input.

In some embodiments, the output indicating the position of the object includes light that is directed towards the object (e.g., a beam of light, a ray of light, and/or a pulsating light). Causing light to be directed towards the object allows the user to visually see a location in the environment where the object is located without needing the object to output anything, thereby providing improved visual feedback to the user and/or performing an operation when a set of conditions has been met without requiring further user input.

In some embodiments, the output indicating the position of the object includes sound output (and, in some embodiments, haptic output) that is directed towards the object (e.g., directional sound, beam sound, and/or focused sound that is directed to a particular location). Causing sound output to be directed towards the object allows the user to identify (e.g., audially) a location in the environment where the object is located without needing the object to output anything, thereby providing improved visual feedback to the user and/or performing an operation when a set of conditions has been met without requiring further user input.

In some embodiments, causing the first set of one or more devices to provide output indicating the position of the object in the environment includes: causing a first device (e.g., 922) in the first set of one or more devices to provide first output based on an orientation of the first device relative to the object; and causing a second device (e.g., 936) in the first set of one or more devices to provide second output based on an orientation of the second device relative to the object. In some embodiments, the first output is different from (e.g., in a different direction from and/or with a different amount of intensity (e.g., light intensity, brightness, sound intensity, and/or color)) the second output. In some embodiments, the orientation (e.g., north, south, east, west, and/or any combination thereof in relation to the x, y, and/or z planes) of the first device relative to the object is different from the orientation of the second device relative to the object. In some embodiments, as a part of causing the second set of one or more devices to provide output indicating the position of the object in the environment, the computer system causes a first device in the second set of one or more devices to provide third output based on an orientation of the first device relative to the object; and causes a second device in the second set of one or more devise to provide fourth output based on an orientation of the second device relative to the object, where the third output is different from (e.g., in a different direction from and/or with a different amount of intensity (e.g., light intensity, brightness, sound intensity, and/or color)) the fourth output. Causing different devices to provide output based on an orientation of those devices relative to the object allows for output to be more narrowly tailored to a location of the object, thereby providing improved visual feedback to the user and/or performing an operation when a set of conditions has been met without requiring further user input.

In some embodiments, the first set of one or more devices includes a first type of device (e.g., a light, a display, a sound, a phone, a computer, a tablet, a wearable device, and/or a fitness tracking device) and a second type of device (e.g., a light, a display, a sound, a phone, a computer, a tablet, a wearable device, and/or a fitness tracking device) that is different from the first type of device. In some embodiments, the first type of device is configured to output a first type of output and the second type of device is configured to output a second type of output different from the first type of output. In some embodiments, the first type of device outputs visual, audio, or haptic output and the second type of device outputs a different one of visual, audio, or haptic output. The different sets of one or more devices including a device of a different type allows for different sets of one or more devices to be better with indicating a location of the object, thereby providing improved visual feedback to the user, reducing the number of inputs needed to perform an operation, and/or performing an operation when a set of conditions has been met without requiring further user input.

In some embodiments, the output indicating the position of the object in the environment is provided for a predetermined period of time (e.g., 1-10 seconds) (e.g., irrespective of whether input is detected and/or the object is found). Providing the output indicating the position of the object in the environment for a predetermined period of time allows such output to extend long enough for a user to locate the object but not for an indefinite period of time requiring the user to stop the output, thereby providing improved visual feedback to the user, reducing the number of inputs needed to perform an operation, and/or performing an operation when a set of conditions has been met without requiring further user input.

In some embodiments, in response to detecting the request to identify the location of the object, the computer system displays, via the display component, an indication (e.g., textual, symbolic, visual, and/or graphic indication, representation, and/or user interface object) (e.g., 930) of the location of the object. In some embodiments, the indication of the location of the object is positioned on a map of the physical environment. In some embodiments, the indication of the location of the object is a point that is displayed on a map. Displaying the indication of the location of the object in response to detecting the request to identify the location of the object allows for the user to have multiple sources of identification of where the object is located, thereby providing improved visual feedback to the user and/or performing an operation when a set of conditions has been met without requiring further user input.

In some embodiments, in response to detecting the request to identify the location of the object, the indication of the location of the object is displayed relative to one or more representations of one or more locations of the first set of one or more devices in the environment and one or more representations of one or more locations of the second set of one or more devices in the environment. In some embodiments, a map includes an indication of the object and an indication of the location of one or more external devices (e.g., one or more external devices that are providing an indication of a location of the object). Displaying the indication of the location of the object relative to one or more representations of one or more locations of the different sets of one or more devices in the environment allows for the user to have multiple sources of identification of where the object is located and the indication in context of output being provided by other devices, thereby providing improved visual feedback to the user and/or performing an operation when a set of conditions has been met without requiring further user input.

In some embodiments, in response to detecting the request to identify the location of the object and in accordance with a determination that the first set of one or more devices meets the respective set of one or more criteria and the second set of one or more devices does not meet the respective set of one or more criteria, the one or more representations of one or more locations of the first set of one or more devices in the environment includes at least one indication (e.g., textual, symbolic, visual, and/or graphic indication, representation, and/or user interface object) (e.g., 922 and/or 932) that the first set of one or more devices is providing output (and, in some embodiments, without the one or more representations of one or more locations of the second set of one or more devices in the environment including at least one indication that the second set of one or more devices is providing output). In some embodiments, in response to detecting the request to identify the location of the object and in accordance with a determination that the first set of one or more devices does not meet the respective set of one or more criteria and the second set of one or more devices meets the respective set of one or more criteria, the one or more representations of one or more locations of the second set of one or more devices in the environment includes at least one indication (e.g., 936, 924, and/or 926) that the second set of one or more devices is providing output (and, in some embodiments, without the one or more representations of one or more locations of the first set of one or more devices in the environment including at least one indication that the first set of one or more devices is providing output). Displaying the indication of the location of the object relative to one or more representations of one or more locations of a sets of one or more devices in the environment providing output allows for the user to have multiple sources of identification of where the object is located and the indication in context of output being provided by other devices, thereby providing improved visual feedback to the user and/or performing an operation when a set of conditions has been met without requiring further user input.

In some embodiments, after causing the first set of one or more devices to provide output indicating the position of the object in the environment, the computer system detects that the object has been retrieved. In some embodiments, in response to detecting that the object has been retrieved, the computer system causes the first set of one or more devices to cease to provide output indicating the position of the object in the environment. In some embodiments, after causing the second set of one or more devices to provide output indicating the position of the object in the environment, the computer system detects that the object has been retrieved. In some embodiments, in response to detecting that the object has been retrieved, the computer system causes the second set of one or more devices to cease to provide output indicating the position of the object in the environment. Causing the first set of one or more devices to cease to provide output in response to detecting that the object has been retrieved allows for such devices to reduce visual and/or noise pollution and/or power consumption when such output is no longer needed, thereby providing improved visual feedback to the user and/or performing an operation when a set of conditions has been met without requiring further user input.

In some embodiments, the respective set of one or more criteria includes a criterion that is met when a determination is made that the object is not mounted (e.g., magnetically mounted and/or connected (e.g., as described above in relation to process 700)). The respective set of one or more criteria including a criterion that is met when a determination is made that the object is not mounted allows output to conditionally occur when the object is not located at an expected and/or mounted location, thereby providing improved visual feedback to the user and/or performing an operation when a set of conditions has been met without requiring further user input.

In some embodiments, detecting the request to identify the location of the object includes detecting an input (e.g., 905a) (e.g., a tap input and/or a non-tap input (e.g., a gaze input, an air gesture, a pointing gesture a swipe input, and/or a mouse click)) on a control (e.g., 920). Detecting the input on the control allows for a user to instruct when to locate the object, providing more control to the user, thereby providing improved visual feedback to the user and/or performing an operation when a set of conditions has been met without requiring further user input.

In some embodiments, in accordance with a determination that the object is mounted, the control is not selectable (e.g., in response to detecting input on the control, the computer system does not perform an operation, such as to identify the location of the object). In some embodiments, in accordance with a determination that the object is not mounted, the control is selectable (e.g., in response to detecting input on the control, the computer system performs an operation, such as to identify the location of the object). Selectively having the control selectable based on whether the object is mounted allows for output of sets of one or more devices to not occur in particular situations and/or a user to identify when the object is not mounted, thereby providing improved visual feedback to the user and/or performing an operation when a set of conditions has been met without requiring further user input.

In some embodiments, in accordance with a determination that the object is mounted, the control is not visible (e.g., is not displayed, is not caused to be displayed, and/or cannot be seen without moving the object). In some embodiments, in accordance with a determination that the object is not mounted (and/or in accordance with a determination that a user is present and/or in accordance with a determination that a user is looking in a direction of the control), the control is visible (e.g., is not displayed, is not caused to be displayed, and/or cannot be seen without moving the object). Selectively having the control visible based on whether the object is mounted allows for output of sets of one or more devices to not occur in particular situations and/or a user to identify when the object is not mounted, thereby providing improved visual feedback to the user and/or performing an operation when a set of conditions has been met without requiring further user input.

Note that details of the processes described above with respect to process 1000 (e.g., FIG. 6) are also applicable in an analogous manner to other methods described herein. For example, process 1200 optionally includes one or more of the characteristics of the various methods described above with reference to process 1000. For example, the object of process 1000 can be the object of process 1200. For brevity, these details are not repeated.

FIGS. 7A-7C illustrate techniques for selectively providing feedback in accordance with some embodiments. The diagrams in these figures are used to illustrate the processes described below, including the processes in FIGS. 8-9.

While described below with respect to a controller device performing operations, it should be recognized that one or more computer systems can perform the operations. For example, a controller device can receive an image from a separate camera and, based on the image, cause a separate smart speaker to output audio. For another example, a camera of a movable computer system can capture an image and, based on the image, cause a light of the movable computer system to turn on.

FIGS. 7A-7C illustrate user 1106 (e.g., a person) looking for an object (e.g., object 1110) within a physical environment (e.g., environment 1100) with several computer systems (e.g., speaker 1104, lights 1112, and couch 1108a). Examples of object 1110 can include a smart phone, a television remote, a smartwatch, car keys, a pen, a piece of paper, and a smart speaker remote. Accordingly, object 1110 can be an electrical device or a non-electrical device, can communicate or not communicate with one or more computer systems, and/or can be located with or without visual inspection (e.g., via environment 1100). As illustrated in FIGS. 7A-7C, environment 1100 is a room of a home. It should be recognized that other objects, environments, and/or computer systems can be used with techniques described herein.

In some embodiments, speaker 1104 is an audio output device configured to output audio into environment 1100. In some embodiments, the audio that speaker 1104 outputs is a media item (e.g., song, music, and/or podcasts) and/or a series of audible tones. In some embodiments, the audio that speaker 1104 outputs can be spatial audio (e.g., audio that is output at some volume in one direction and another volume in another direction). In other embodiments, the audio that speaker 1104 outputs is not spatial audio. In some embodiments, lights 1112 is a set of one or more lights, installed into a ceiling of environment 1100, configured to output light into environment 1100. In some embodiments, lights 1112 can cause light to be directed in certain directions. In some embodiments, couch 1108a is a chair that includes a couch leg (e.g., couch leg 1108b) that is able to change position using an actuator in response to a request.

In some embodiments, the controller device assisting user 1106 is able to identify the location of object 1110 (e.g., by visual inspection, memory, or non-visual triangulation). In such embodiments, the controller device can lead user 1106 to object 1110. For example, the controller device can cause output of one or more computer systems to cause user 1106 to look and/or move in a particular direction. As user moves in the particular direction, the controller device can change output of one or more computer systems to further cause user 1106 to look and/or move in a particular direction until user 1106 finds object 1110, as discussed further below with respect to FIGS. 7A-7C.

In some embodiments, the controller device assisting user 1106 does not know the location of object 1110. In such embodiments, as user 1106 looks around environment 1100, the controller device can cause computer systems in environment 1100 to change states to aid user 1106. As user 1106 continues to look around, the controller device can cause the same computer systems and/or different computer systems to change states to attempt to continue to aid user 1106. For example, if user 1106 looks to the right, light in environment 1100 can be directed to the right side of user 1106. If user 1106 bends down and looks toward a bottom of couch 1108a, couch leg 1108b can lower while light is directed where couch leg 1108b used to be.

Turning to FIG. 7A, the controller device can be operating in a normal mode, a mode where one or more computer systems in environment 1100 are operating as previously set (e.g., by user 1106 and/or another user). For example, speaker 1104 can be outputting audio 1102 at a first volume (e.g., set by user 1106), lights 1112 can be outputting light at a first brightness level generally throughout environment 1100, and couch leg 1101b can be raised. Note that the size of audio 1102 correlates to the volume of audio 1102 (e.g., small indicators signify a low volume and large indicators signify a high volume). As illustrated in FIG. 7A, object 1110 is positioned under couch leg 1108b, obstructed from view of user 1106.

At FIG. 7A, the controller device changes to an object locator mode, a mode that allows the controller device to assist user 1106 in finding an object. In some embodiments, the object locator mode is activated in response to detecting an input from user 1106, such as a tap input on a touch-sensitive surface, a verbal request, an air gesture, and/or user 1106 being determined to be looking around environment 1100 for an object.

In some embodiments, the object locator mode corresponds to a specific user (e.g., an owner of the controller device, a primary user, and/or a designated user, such as a user that caused the controller device to change to the object locator mode). In such embodiments, assistance by the controller device can correspond to the specific user and not other users. For example, as the specific user moves around environment 1100, the controller device can cause different computer systems to change states to assist the specific user. However, as another user moves around environment 1100, the controller device might not cause different computer systems to change states to assist the other user.

At FIG. 7A (e.g., while in the object locator mode and/or to cause the object locator mode to be activated), the controller device detects (e.g., via a camera, a wearable device using a gyroscope, and/or another sensor) that user 1106 turns toward couch 1108a and/or object 1110.

As illustrated in FIG. 7B, in response to detecting that user 1106 turns, the controller device causes speaker 1104 to decrease a volume of audio output (e.g., in contrast to the volume of the audio output of speaker 1104 as illustrated at FIG. 7A). That is, the volume of speaker 1104 is reduced based on user 1106 turning. Such a change can be to reduce distractions while user 1106 is looking for object 1110. In some embodiments, instead of and/or in addition to lowering a volume, the controller device causes speaker 1104 to direct audio output (e.g., spatial audio) to a direction towards object 1110 so as to guide user 1106 closer to object 1110. For example, the controller device can cause speaker 1104 to output audio at an increased volume in a direction towards object 1110 and at a decreased volume in a direction away from object 1110. In some embodiments, in addition to and/or instead of decreasing the volume of speaker 1104, the controller device causes lights 1112 to light a general area of couch 1108a. In such embodiments, the light can be used to indicate that object 1110 is generally located by couch 11108a and/or light an area in which user 1106 is looking. Notably, one or more other computer systems in environment 1100 might not be affected by user 1106 turning toward couch 1108a. For example, couch 1108a does not move in response to user 1106 turning.

At FIG. 7B, user 1106 moves from a standing position to a crouching position. At FIG. 7C, in response to detecting user 1106 in the crouching position, the controller device causes speaker 1104 to stop outputting audio (e.g., as indicated by the absence of audio 1102 in FIG. 7C). Such change to the audio can be to reduce distraction even further as user 1106 has continued to look for object 1110.

As illustrated in FIG. 7C, in response to detecting user 1106 in the crouching position, the controller devices causes couch leg 1108b to recede into couch 1108a (e.g., via an actuator of couch 1108a). In some embodiments, in response to detecting user 1106 in the crouching position, the controller devices causes lights 1112 to direct light toward where couch leg 1108b used to cover (e.g., as illustrated in FIGS. 7A-7B). In some embodiments, the rate of light output by lights 1112 is based on the rate of movement of user 1106. That is, as user 1106 moves in environment 1100, lights 1112 can light a path toward object 1110 in increments as user 1106 gets closer to object 1110 (e.g., lights 1112 does not output an entire path of light from user 1106 to object 1110).

Notably, multiple different types of computer systems have been modified in response to detecting user 1106 in the crouching position. Such examples illustrate that the controller device can utilize different types of output (e.g., sound, light, and/or movement) to assist in locating object 1110. It should be recognized that, in some embodiments, some movements do not cause the controller device to change what is output. Instead, the controller device maintains what is currently output to assist user 1106 even when user 1106 is moving and/or changing position within environment 1100.

At FIG. 7C, because couch leg 1108b has receded into couch 1108a, object 1110 is visible to user 1106. In some embodiments, speaker 1104 emits a sound before and/or after couch leg 1108b recedes into couch 1108a, indicating that object 1110 has been revealed.

In some embodiments, the controller device caters which computer systems are used and/or what output is used while assisting user 1106 to find object 1110. In such embodiments, the controller device can select computer systems and/or output based on a current position and/or movement of user 1106 relative to the location of object 1110. For example, the controller device can use light when user 1106 is further away from object 1110 and movement when user 1106 is closer to object 1110.

FIG. 8 is a flow diagram illustrating a method (e.g., process 1200) for adjusting output of devices in accordance with some embodiments. Some operations in process 1200 are, optionally, combined, the orders of some operations are, optionally, changed, and some operations are, optionally, omitted.

As described below, process 1200 provides an intuitive way for adjusting output of devices. Process 1200 reduces the cognitive burden on a user for adjusting output of devices, thereby creating a more efficient human-machine interface. For battery-operated computing devices, enabling a user to adjust output of devices faster and more efficiently conserves power and increases the time between battery charges.

In some embodiments, process 1200 is performed at a computer system that is in communication a first set of one or more devices (e.g., a light, a speaker, a phone, a tablet, a processor, a head-mounted display (HMD) device, a vehicle, a smart chair, a smart piece of furniture, a smart gate, a smart door, a smart portion of a house, boat, and/or vehicle, and/or a personal computing device) (e.g., 1104, 1112, and/or 1108) that does not include an object (e.g., a device and/or a remote control) (e.g., 1110). In some embodiments, the computer system is in communication with a second set of one or more devices (e.g., a light, a speaker, a phone, a tablet, a processor, a head-mounted display (HMD) device, and/or a personal computing device) that does not include the object, and one or more input devices (e.g., a physical input mechanism, a camera, a touch-sensitive display, a microphone, and/or a button). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras). In some embodiments, the computer system is in communication with a display component (e.g., a display screen and/or a touch-sensitive display). In some embodiments, the first set of one or more devices is not a part of the computer system.

While causing the first set of one or more devices to provide first output (e.g., 1102, as described above with respect to FIG. 7B) that indicates where the object is located (e.g., a sound output, a light output, a vibration output (e.g., in a direction (e.g., north, east, west, south, or any combination thereof) and/or at a particular degree (e.g., volume, intensity, and/or color))) (e.g., output that is in and/or is perceived to be in one or more directions (e.g., from a location that corresponding to the object and a location that corresponds to the user, from the location that corresponds to the user to the location corresponding to the object, from a device to the object, and/or from the device to the user)), the computer system detects (1202) a change in a positional relationship (e.g., change in orientation, positioning, and/or distance) (e.g., as described above with respect to FIG. 7C) between a first user (e.g., 1106) and the object (e.g., detecting a change in position of the user relative to the object and/or the object relative to the user) (e.g., movement of a user and/or the object (e.g., from a first position to a second position that is different from the first position) (e.g., via one or more cameras and/or motion sensors that are in communication with the computer system)).

In response to detecting the change in the positional relationship between the first user and the object, the computer system causes (1204) the first set of one or more devices to provide second output (e.g., 1108b and/or 1112) that indicates where the object is located, wherein the second output is different from (e.g., is in a different direction than, has a different intensity than, and/or is in a different type of output than) the first output. Causing the first set of one or more devices to provide second output that indicates where the object is located in response to detect the change in the positional relationship between the first user and the object allows the computer system to perform an operation that directs the user to the location of the object, thereby providing improved feedback and providing the user with one or more additional control options without cluttering the user interface.

In some embodiments, the first output corresponds to a light that is output in a first direction (e.g., the first direction is towards the location of the object or the first direction is away from the location of the object). In some embodiments, the second output corresponds to a light that is output in a second direction different from the first direction (e.g., the second direction is towards the location of the object or the second direction is away from the location of the object) (e.g., the first direction overlaps with the second direction or the first direction does not overlap with the second direction). In some embodiments, the first direction and the second direction correspond to the positional relationship between the first user and the object. In some embodiments, the brightness of the first output of light is greater than or less than the brightness of the second output of light. In some embodiments, the brightness of the first output of light and/or the second output of light corresponds to the distance between the object and the user. Changing the direction in which a light is directed in response to detecting the change in the positional relationship between the user and the object allows the computer system to direct the user to the positioning of the object, thereby providing improved feedback and providing the user with one or more additional control options without cluttering the user interface.

In some embodiments, the first output includes audio (e.g., spatial audio) with a first spatial property of output (e.g., audio that is output in a particular spatial direction and/or that will be heard from different locations in space and/or in one or more dimensions). In some embodiments, the second output includes audio (e.g. spatial audio) with a second spatial property of output different from the first spatial output. In some embodiments, audio with the second spatial property can be heard and/or is directed to (e.g., output to be heard) at different locations in space and/or at different volumes levels at different locations in space as compared to audio with the first spatial property. In some embodiments, the first output has a first volume level directed in a third direction and not a fourth direction and has a second volume level directed in the fourth direction and not the third direction. In some embodiments, the first volume level is different from the second volume level (e.g., the second volume level is greater than, less than, or the same as the first volume level) (e.g., the third direction is different and/or distinct from the fourth direction) (e.g., the third direction is the direction towards the object relative to the location of the first user or the third direction or the third direction is the direction towards away from the object relative to the location of the first user). In some embodiments, the second output has a third volume level directed in the fourth direction and not the third direction and has a fourth volume level directed in the third direction and not the fourth direction. In some embodiments, the third volume level is different from the fourth volume level. (e.g., the third direction is different and/or distinct from the fourth direction). In some embodiments, the third direction and the fourth direction correspond to the positional relationship between the first user and the object. In some embodiments, the aggregate volume of the first volume level and the second volume level is greater than or less than the aggregate volume of third volume level and the fourth volume level. Changing the spatial property of an audio output in response to detecting the change in the positional relationship between the user and the object allows the computer system to direct the user to the positioning of the object, thereby providing improved feedback and providing the user with one or more additional control options without cluttering the user interface.

In some embodiments, the positional relationship between the first user and the object changes at a rate of speed (e.g., measured in feet per second, meters per second, miles per hour, and/or inches per second) (e.g., detected via one or more sensors that are integrated into the computer system or external to the computer system). In some embodiments, in accordance with a determination that the rate of speed corresponds to a first rate of speed, the second output has a first rate of output (e.g., measured in beats per minute, light pulses per minute, light pulses per second, vibrations per minute, and/or vibrations per second). In some embodiments, in accordance with a determination that the rate of speed corresponds to a second rate of speed different from the first rate of speed, the second output has a second rate of output different from the first rate of output (e.g., measured in beats per minute, light pulses per minute, light pulses per second, vibrations per minute, and/or vibrations per second). In some embodiments, the rate at which the first set of one or more devices output the second output is based on a rate of speed of movement of the user and/or object. In some embodiments, the rate of output that corresponds to the second output is different from the rate of output that corresponds to the first output. In some embodiments, while outputting the first output, the computer system and/or the first user and/or object is moving. Causing the first set of one or more devices to output the second output at one or more rates based on the rate of speed of the change in the positional relationship between the first user and the object indicates to a user how fast the distance between there user and the object is changing, thereby providing improved feedback and providing the user with one or more additional control options without cluttering the user interface.

In some embodiments, in response to detecting the change in the positional relationship between the first user and the object and in accordance with a determination that the first user and the object have a first positional relationship (e.g., the first user is positioned to the left, above, below, to the right, in front of, behind of the object) (e.g., the distance between the first user and the object is greater than or less than a distance threshold (e.g., 1-25 feet)) after detecting the change in the positional relationship between the first user and the object, the second output has a first set of characteristics (e.g., direction, brightness, volume, beats per minute, flashes per minute, and/or color). In some embodiments, in response to detecting the change in the positional relationship between the first user and the object and in accordance with a determination that the first user and the object have a second positional relationship (e.g., the second positional relationship is different and/or distinct from the first positional relationship), different from the first positional relationship, after detecting the change in the positional relationship between the first user and the object, the second output has a second set of characteristics (e.g., direction, brightness, volume, beats per minute, flashes per minute, and/or color), different from the first set of characteristics (e.g., the output with the second set of characteristics is louder than the output with the first of characteristics, the output with the second set of characteristics is quieter than the output with the first set of characteristics, the output with the second set of characteristics is brighter than the output with the first set of characteristics, the second set of characteristics corresponds to a quicker rate of output than the first set of characteristics, the second set of characteristics corresponds to a slower rate or output than the first set of characteristics). In some embodiments, the intensity of the second output and the distance between the first user and the object are directly correlated. In some embodiments, the intensity of the second output and the distance between the first user and the object are inversely correlated. Causing the first set of one or more devices to output the second output with different sets of characteristics based on the positional relationship between the user and the object allows the computer system to direct the user to the positioning of the object, thereby providing improved feedback and providing the user with one or more additional control options without cluttering the user interface.

In some embodiments, before detecting the change in the positional relationship between the first user and the object, the first set of one or more devices is in a first position (e.g., 1108b, as illustrated in FIG. 7B) (e.g., a closed position, a folded position, an unfolded position, a side position, a forward position, and/or a down position). In some embodiments, causing the first set of one or more devices to provide the second output includes moving the first set of one or more devices from the first position to a second position (e.g., 1108b, as illustrated in FIG. 7C) different from the first position. In some embodiments, the first position is the opposite of the second position (e.g., the first position is 180 degrees displaced from the second position, the first set of devices is stretched out while in the first position and the first set of one or more devices is collapsed while in the second position, and/or the first set of one or more devices is erect while in the first position and the first set of one or more devices is not erect while in the second position). In some embodiments, the first set of one or more devices obscures the object while the first set of one or more devices is in the first position and the first set of one or more devices does not obscure the object while the first set of one or more devices is in the second position. In some embodiments, the first set of one or more devices obscures the object while the first set of one or more devices is in the first position and the second position. Moving the first set of one or more devices from the first position to the second position as part of causing the first set of one or more devices to provide second output indicates to a user the positioning of the object, thereby providing improved feedback and providing the user with one or more additional control options without cluttering the user interface.

In some embodiments, the first output and the second output are a same type of output (e.g., the first output and second output are audio outputs, light outputs, and/or haptic outputs). In some embodiments, the second output and the first output are different types of outputs. In some embodiments, the intensity of the first output is greater than or less than the intensity of the second output. In some embodiments, the intensity of the first output is the same as the intensity of the second output.

In some embodiments, the computer system is in communication with a second set of one or more devices (e.g., a light, a speaker, a phone, a tablet, a processor, a head-mounted display (HMD) device, a vehicle, a smart chair, a smart piece of furniture, a smart gate, a smart door, a smart portion of a house, boat, and/or vehicle, and/or a personal computing device) (e.g., 1104, 1112, and/or 1108), different from the first set of one or more devices, that does not include the object, and wherein the change in the positional relationship between the first user and the object is detected while causing the second set of one or more devices to provide third output that indicates where the object is located. In some embodiments, in response to detecting the change in the positional relationship between the first user and the object, the computer system causes the second set of one or more devices to output fourth output that indicates where the object is located, wherein the fourth output is different (e.g., different intensity, different type (e.g., the third output is an audio output and the fourth output is a tactile output or the third d output is a visual output and the fourth output is an audio output), and/or different duration) from the second output and the third output. In some embodiments, the fourth output and the first output, second output, and/or the third output are the same type of outputs. In some embodiments, the fourth output and the first output, second output, and/or the third output are different types of output. In some embodiments, the second set of devices output the fourth output while, before and/or after the first set of devices output the second output. Causing the second set of one or more devices to output fourth output that is different from the second output and third output in response to detecting the change in the positional relationship between the first user and the object, allows two more devices to simultaneously indicate the positioning of an object relative to a user, thereby providing improved feedback and providing the user with one or more additional control options without cluttering the user interface.

In some embodiments, the computer system is in communication with a third set of one or more devices (e.g., a light, a speaker, a phone, a tablet, a processor, a head-mounted display (HMD) device, a vehicle, a smart chair, a smart piece of furniture, a smart gate, a smart door, a smart portion of a house, boat, and/or vehicle, and/or a personal computing device), different from the first set of one or more devices, that does not include the object, and wherein the change in the positional relationship between the first user and the object is detected while causing the third set of one or more devices to provide fifth output that indicates where the object is located. In some embodiments, in response to detecting the change in the positional relationship between the first user and the object, the computer system continues to cause (e.g., maintain and/or persist) the third set of one or more devices to provide the fifth output. In some embodiments, in response to detecting the change in the detecting the change in the positional relationship between the first user and the object, the computer system does not cause the third set of one or more devices to provide an output that is different from the fifth output.

In some embodiments, while causing the first set of one or more devices to provide the first output, the computer system detects a change in a positional relationship between a second user (e.g., the second user is different and/or distinct from the first user) and the object (e.g., the change in the positional relationship between the second user and the object is detected before, after, or while the change in the positional relationship between the first user is and the object is detected) (e.g., before, while, and/or after detecting the change in the positional relationship between the first user and the object). In some embodiments, in response to detecting the change in the positional relationship between the second user and the object, the computer system forgoes causing the first set of one or more devices to provide an output (e.g., that indicates where the object is located) that is different from the first output. In some embodiments, in response to detecting the change in the positional relationship between the second user and the object, the computer system continues to cause the first set of one or more devices to provide the first output. In some embodiments, in response to detecting the change in the positional relationship between the second user and the object, the computer system does not cause the first set of one or more devices to provide the second output. In some embodiments, the computer system causes the first set of one or more devices to provide a different output in response to detecting the change in the positional relationship between the second user and the object.

In some embodiments, the first user is a targeted user (e.g., the first user is targeted by the computer system and/or targeted by the user) (e.g., the first user is an owner, primary user and/or designated user). In some embodiments, the second user is a non-targeted user (e.g., the computer system does not track the movement of the second user, the second user does not correspond to a user account that corresponds to the computer system, and/or the second user is not registered (e.g., via a user account and/or a phone number) with the computer system). In some embodiments, the computer system tracks the movement of the first user and the computer system does not track the movement of other respective users. In some embodiments, the computer system tracks the movement of the first user and the computer system tracks the movement of other respective users. In some embodiments, the first user is registered (e.g., via a user account and/or phone number) with the computer system. Not causing the first set of one or more devices to provide an output that is different from the first output in response to detecting a change in the positional relationship between the non-targeted user allows the computer system to provide targeted feedback and reduces the amount of distracting feedback that the computer system outputs, thereby providing improved feedback.

In some embodiments, the computer system is in communication (e.g., wired communication and/or wireless communication (e.g., Bluetooth, Wi-Fi, and/or Ultra-Wideband)) with a fourth set of one or more devices (e.g., a light, a speaker, a phone, a tablet, a processor, a head-mounted display (HMD) device, a vehicle, a smart chair, a smart piece of furniture, a smart gate, a smart door, a smart portion of a house, boat, and/or vehicle, and/or a personal computing device), different from the first set of one or more devices, that does not include the object. In some embodiments, in response to detecting the change in the positional relationship between the first user and the object, the computer system causes the fourth set of one or more devices to move (e.g., lower, rise, move translationally, and/or rotate) from a first location to a second location (e.g., the first location and the second location are locations within an area (e.g., a room, a building, a side (e.g., front, back, left, and/or right side) (e.g., passenger, driver, and/or operator side) of a vehicle, a side of a yard, a side of a boat, and/or a side of a house) or the first location and the second location are located in different areas) (e.g., the second location is different and/or distinct from the first location). In some embodiments, the computer system causes the fourth set of one or more devices to move from the first location to the second location, before, after and/or while the computer system causes the first set of one or more devices to output the second output. In some embodiments, the computer system causes the fourth set of one or more devices to move from the second location to the first location after the computer system causes the fourth set of one or more devices to move from the first location to the second location. Causing the first set of one or more devices to move from a first location to a second location in response to detecting the change in the positional relationship between the first user and the object allows the computer system to make the object visible to a user, thereby providing improved feedback and providing the user with one or more additional control options without cluttering the user interface.

In some embodiments, while the fourth set of one or more devices is in the first location, the fourth set of one or more devices is located between the user and the object (e.g., the fourth set of one or more devices is in a path between the user and the object and/or the fourth set of one or more devices obstructs the user's view of the object while the fourth set of one or more devices is positioned in the first location). In some embodiments, the fourth set of one or more devices is not located between the user and the object while the fourth set of one or more devices is in the second position. Causing the fourth set of one or more devices to move from a first location that is between the user and the object to a second location allows the computer system to make the object visible to the user, thereby providing improved feedback and providing the user with one or more additional control options without cluttering the user interface.

In some embodiments, before causing the fourth set of one or more devices to move from the first location to the second location, the fourth set of one or more devices obscures (e.g. partially obscures from a respective user or completely obscures from the respective user) the object (e.g., the fourth set of one or more devices obscures the object such that the object is not visible to a user, is partially not visible to a user, and/or the fourth set of one or more devices partially obscures the object from the user). In some embodiments, the fourth set of one or more objects does not obscure the object while the fourth set of one or more objects is positioned at the second location. In some embodiments, the fourth set of one or more devices obscures the object while the fourth set of one or more devices is at the first location. In some embodiments, the fourth set of one or more devices does not obscure the object while the object is at the second location. Causing the fourth set of one or more devices to move from a first location that obscures the object to a second location allows the computer system to make the object visible to the user, thereby providing improved feedback and providing the user with one or more additional control options without cluttering the user interface.

Note that details of the processes described above with respect to process 1200 (e.g., FIG. 8) are also applicable in an analogous manner to other methods described herein. For example, process 700 optionally includes one or more of the characteristics of the various methods described above with reference to process 1200. For example, the first set of devices of process 1200 can be controlled via the first set of one or more controls or the second set of one or more controls of process 700. For brevity, these details are not repeated.

FIG. 9 is a flow diagram illustrating a method (e.g., process 1300) for providing contextual based feedback in accordance with some embodiments. Some operations in process 1300 are, optionally, combined, the orders of some operations are, optionally, changed, and some operations are, optionally, omitted.

As described below, process 1300 provides an intuitive way for providing contextual based feedback. Process 1300 reduces the cognitive burden on a user for obtaining feedback, thereby creating a more efficient human-machine interface. For battery-operated computing devices, enabling a user to obtain feedback faster and more efficiently conserves power and increases the time between battery charges.

In some embodiments, process 1300 is performed at a computer system that is in communication with a first set of one or more devices (e.g., a light, a speaker, a phone, a tablet, a processor, a head-mounted display (HMD) device, a vehicle, a smart chair, a smart piece of furniture, a smart gate, a smart door, a smart portion of a house, boat, and/or vehicle, and/or a personal computing device) (and, in some embodiments, the first set of one or more devices does not include an object (e.g., a device and/or a remote control)) (e.g., 1104, 1108, and/or 1112). In some embodiments, the first set of one or more devices are not a part of the computer system. In some embodiments, the computer system is in communication with a second set of one or more devices (e.g., a light, a speaker, a phone, a tablet, a processor, a head-mounted display (HMD) device, and/or a personal computing device) that does not include the object, and one or more input devices (e.g., a physical input mechanism, a camera, a touch-sensitive display, a microphone, and/or a button). In some embodiments, the computer system is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with a display component (e.g., a display screen and/or a touch-sensitive display).

While causing the first set of one or more devices to operate in a first manner (e.g., as described above with respect to FIG. 7A) (e.g., light up an area corresponding to a user, output audio in a particular location, or be in a particular position, interior is dark in the first manner) (e.g., provide a sound output, a light output, and/or a vibration output (e.g., in a direction (e.g., north, east, west, south, or any combination thereof) and/or at a particular degree (e.g., volume, intensity, and/or color))) (e.g., output that is in and/or is perceived to be in one or more directions (e.g., from a location that corresponds to the object to a location that corresponds to the user, from the location that corresponds to the user to the location corresponding to the object, from a device to the object, and/or from the device to the user)), the computer system detects (1302) a first movement (e.g., as described above with respect to FIG. 7B) of a user (e.g., 1106) (e.g., from a first position to a second position that is different from the first position and/or in a first body position (e.g., sitting, standing, bending, and/or kneeling) to a second body position (e.g., sitting, standing, bending, and/or kneeling) (e.g., via one or more cameras and/or motion sensors that are in communication with the computer system)).

In response to (1304) detecting the first movement of the user (e.g., from a first position to a second position that is different from the first position), in accordance with a determination that (and/or while) a first context is present (e.g., the computer system is operating in the first context and/or movement of the user is the first context (e.g., the position of the user is a particular position (e.g., bending down, standing up, and/or kneeling))) (e.g., after detecting movement of the user), the computer system causes (1306) the first set of one or more devices to operate in a second manner (e.g., light up an area under a seat, output audio in a different location, or move seat) that is different from the first manner (e.g., as described above with respect to FIG. 7B). In some embodiments, the first context includes a determination that the user has a first intent (e.g., a predicted intent and/or a determined intent). In some embodiments, the first context includes a determination that the user is looking in a first direction. In some embodiments, the first context includes a determination that an object is located in a direction that the user is looking. In some embodiments, the first context includes that the computer system is moving. In some embodiments, the first context includes a determination that the user is outside of the computer system. In some embodiments, the first context does not include verbal and/or physical input by the user.

In response to (1304) detecting the first movement of the user, in accordance with a determination that (and/or while) a second context is present (e.g., the computer system is operating in the second context and/or movement of the user is the second context (e.g., the position of the user is a particular position (e.g., bending down, standing up, and/or kneeling))) (e.g., after detecting movement of the user), the computer system causes (1308) the first set of one or more devices to operate in a third manner (e.g., as described above with respect to FIG. 7C) different from the second manner and the first manner (e.g., without, in some embodiments, causing the first set of one or more devices to operate in the second manner and/or the first manner). In some embodiments, the second context includes a determination that the user has a second intent (e.g., a predicted intent and/or a determined intent) different from the first intent. In some embodiments, the second context includes a determination that the user is looking in a second direction different from the first direction. In some embodiments, the second context includes a determination that the computer system is stopped. In some embodiments, the second context includes a determination that the user is inside of the computer system. In some embodiments, the second context does not include verbal and/or physical input by the user. In some embodiments, the first context and/or the second context is with respect to the computer system. In some embodiments, the first context and/or the second context is with respect to the user. ISE the first context and/or the second context is with respect to an object separate from and/or not in communication with the computer system. Causing the first set of one or more devices to operate in a particular manner based on which context is present allows the computer system to automatically control the operation of the first set one or more devices to indicate to a user the context of the computer system and/or the user, thereby providing improved feedback and providing the user with one or more additional control options without cluttering the user interface.

In some embodiments, the first set of one or more devices includes (and/or is a set of one or) one or more output devices (e.g., a light, television, radio, tablet, display, head mounted display, and/or a speaker) (e.g., a device that provides an output that is detectable by one or more senses of an individual). In some embodiments, the first set of one or more devices includes a first type of output device (e.g., a light or a speaker) and includes a second type of output device (e.g., a light or a speaker) that is a different type of output device than the first type of output device.

In some embodiments, causing the first set of one or more devices to operate in the first manner (and/or second manner) includes causing the first set of one or more devices to provide a first output in a first direction (e.g., in a direction towards the user and/or in a direction away from the user) (e.g., above, below, and/or to the side of the first set of one or more devices) without causing the first set of one or more devices to provide the first output in a second direction. In some embodiments, causing the first set of one or more devices to operate in the second manner includes causing the first set of one or more devices to provide the first output in the second direction without causing the first set of one or more devices to provide the first output in the first direction (e.g., above, below, and/or to the side of the first set on or more devices). In some embodiments, the first direction overlaps with the second direction. In some embodiments, the first direction does not overlap with the second direction. In some embodiments, the first direction is opposite the second direction, the second direction is perpendicular to the first direction, and/or the second direction is at an angle to the first direction. In some embodiments, causing the first set of one or more devices to operate in the first manner includes causing the first set of one or more devices to direct (e.g., an audio output, a visual output and/or a haptic output) a respective output towards a first location without causing the first set of one or more devices to direct the respective output towards a second location (e.g., closer to the first set of one or more devices than the first location, further from the first set of one or more devices than the first location, and/or on a different side of the first set of one or more devices than the first location) (and/or output, such as light or sound is detected at the first location and not the second location) and wherein causing the first set of one or more devices to operate in the second manner includes causing the first set of one or more devices to direct the respective output (e.g., the third output) towards the second location without causing the first set of one or more devices to direct the respective output towards the first location (and/or output, such as light or sound is detected at the second location and not the first location). In some embodiments, the second location overlaps with the first location. In some embodiments, the second location does not overlap with the first location. In some embodiments, the first location and the second location (e.g., rooms in a home or areas within an automobile) are sub locations within a primary location. Causing the first set of one or more devices to provide output in a particular direction based on whether a context is present allows the computer system to indicate the context of both the computer system and the user, thereby providing improved feedback and providing the user with one or more additional control options without cluttering the user interface.

In some embodiments, the first output propagates (e.g., spreads, disseminates, and/or emanates) throughout a physical environment (e.g., a physical environment that surrounds the computer system, a physical environment within the computer system, and/or a physical environment that does not surround the computer system (e.g., the physical environment is external to the computer system and/or the computer system is not within the physical environment)).

In some embodiments, causing the first set of one or more devices to operate in the in the first manner includes causing the first set of one or more devices to provide a second output with a first spatial property (e.g., audio that is output in a particular spatial direction and/or that will be heard from different locations in space and/or in one or more dimensions). In some embodiments, causing the first set of one or more devices to operate in the second manner includes causing the first set of one or more devices to provide the second output with a second spatial property (e.g., audio that is output in a particular spatial direction and/or that will be heard from different locations in space and/or in one or more dimensions) different from the first spatial property (e.g., different direction, different volume, and/or different audio characteristics). In some embodiments, the volume of the output device is lowered as the computer system detects that is a user is searching for something and/or moving toward something (e.g., the object). Causing the first set of one or more devices to provide output with a particular type of spatial property based on whether a context is present allows the computer system to indicate the context of both the computer system and the user, thereby providing improved feedback and providing the user with one or more additional control options without cluttering the user interface.

In some embodiments, the first set of one or more devices includes an actuator (e.g., a pneumatic actuator, hydraulic actuator or an electric actuator). In some embodiments, causing the first set of one or more devices to operate in the second manner includes causing the actuator to move from a first position (e.g., 1108b as described above with respect to FIG. 7B) to a second position (e.g., 1108b as described above with respect to FIG. 7C), different (e.g., the second position is removed from the first position and/or the second position is distinct from the first position) from the first position. In some embodiments, the first position is closer to the user than the second position or vice versa. In some embodiments, causing the actuator to move from the first position to the second position causes a device, such as a smart furniture, a smart chair, a smart door, a smart accessory, and/or a smart gate to move.

In some embodiments, the computer system is in communication (e.g., wireless communication and/or wired communication) with a second set of one or more devices (e.g., a light, a speaker, a phone, a tablet, a processor, a head-mounted display (HMD) device, a vehicle, a smart chair, a smart piece of furniture, a smart gate, a smart door, a smart portion of a house, boat, and/or vehicle, and/or a personal computing device) (and, in some embodiments, the first set of one or more devices does not include an object (e.g., a device and/or a remote control)), and wherein, before detecting the first movement of the user, the computer system causes the second set of one or more devices to operate in a fourth manner (e.g., different from or the same as the first and/or second manner). In some embodiments, in response to detecting the first movement of the user, the computer system causes the second set of one or more devices to operate in a fifth manner different from the fourth manner (e.g., the second set of devices is louder, brighter, rotates faster, quieter, rotates slower and/or is less bright when the second set of one or more devices operate in the fifth manner than when the second set of one or more devices operate in the fourth manner). In some embodiments, the fifth manner is different from the first manner, the second manner, and/or the third manner. In some embodiments, the fourth manner is different from the first manner, the second manner, and/or the third manner. Causing the second set of one or more devices to operate in a fifth manner in response to detecting the first movement of the user allows the user to control the operating of the second set of one or more devices without requiring that the computer system display a respective user interface element, thereby providing the user with one or more additional control options without cluttering the user interface.

In some embodiments, the computer system is in communication (e.g., wireless communication and/or wired communication) with an external wearable device (e.g., a smartwatch, a head mounted display, a fitness tracking device, a head mounted display, and/or smart glasses). In some embodiments, the first movement of the user is detected via the external wearable device (e.g., the computer system measures the signal strength of a wireless signal that the external wearable device transmits to the computer system and/or the computer system determines the distance between the external wearable device and the computer system). In some embodiments, the movement of the user is detected via one or more cameras of the external wearable device. In some embodiments, the movement of the user is detected via one or more sensors of the external wearable device.

In some embodiments, the computer system is in communication with a set of one or more cameras (e.g., the one or more cameras are external to the computer system or the one or more cameras are integrated into the computer system). In some embodiments, the first movement of the user is detected via image data that is captured via the set of one or more cameras. In some embodiments, the set of one or more cameras is integrated into the computer system. In some embodiments, the set of one or more cameras is external to the computer system.

In some embodiments, while causing the first set of one or more devices to operate in the first manner and while the user is in a focus area (e.g., a respective seat and/or area of a mobile system (e.g., an airplane, boat, and/or automobile), an area that is within a wireless communication range of the computer system, an area that is within the field of view of one or more cameras, and/or a respective area of a mobile system) (e.g., a room, a building, a side (e.g., front, back, left, and/or right side) (e.g., passenger, driver, and/or operator side) of a vehicle, a side of a yard, a side of a boat, and/or a side of a house), the computer system detects a second movement (e.g., that's the same or different from the first movement) of the user (e.g., the second movement of the user is detected before or after the first movement of the user is detected). In some embodiments, in response to detecting the second movement of the user, in accordance with a determination that the user is positioned within the focus area (a portion of the user is positioned within the focus area or the entirety of the user is positioned within focus area), the computer system causes the first set of one or more devices to continue to operate in the first manner. In some embodiments, in response to detecting the second movement of the user, in accordance with a determination that the user is not positioned within focus area (a portion of the user is positioned within the focus area or the entirety of the user is positioned within focus area), the computer system causes the first set of one or more devices to operate in a fifth manner that is different from the first manner. In some embodiments, the first set of one or more devices transitions from operating in the first manner to operating in the fifth manner in response to the user transitioning from being positioned within the focus area to being positioned outside of the focus area. In some embodiments, the computer system causes the first set of one or more devices to continue to operate in the first manner or operate in the fifth manner in response to detecting the end of the second movement of the user. In some embodiments, the user is not positioned within the computer system while the user is not positioned within the focus area. In some embodiments, the user does not have access to various functionalities of the computer system while the user is in the focus area or while the user is not in the focus area. Causing the first set of one or more devices to operate in a particular manner based on the positioning of the user automatically allows the computer system to control the operation of the first set of one or more devices to indicate the positioning of the user, thereby performing an operation when a set of conditions has been met without requiring further user input and providing improved feedback.

In some embodiments, the first movement of the user is not detected via a motion sensor. In some embodiments, the movement of the user is detected via a motion sensor.

In some embodiments, the first context corresponds to a first state of movement of the computer system (e.g., the computer system is not moving, the computer system is moving, the computer system is deaccelerating, the computer system is accelerating, the speed of the computer system is above a speed threshold, and/or the speed of the computer system is below a speed threshold). In some embodiments, the second context corresponds to a second state of movement of the computer system, different from the second state of movement (e.g., the computer system is not moving, the computer system is moving, the computer system is deaccelerating, the computer system is accelerating, the speed of the computer system is above a speed threshold, and/or the speed of the computer system is below a speed threshold). Causing the first set of one or more devices to operate in a respective manner based on a movement state of the computer system allows the computer system to control the operation of the first set of one or more devices to indicate the present movement state of the computer system, thereby providing improved feedback and performing an operation when a set of conditions has been met without requiring further user input and providing improved feedback.

In some embodiments, the first context corresponds to a first operational state of the computer system (e.g., the computer system is powered off, the computer system is powered on, the computer system is in a sleep state, the computer system plays back media, the computer system is in an unlock state, and/or the computer system is in a lock state). In some embodiments, the second context corresponds to a second operational state of the computer system (e.g., the computer system is powered off, the computer system is powered on, the computer system is in a sleep state, the computer system plays back media, the computer system is in an unlock state, and/or the computer system is in a lock state) (e.g., the second operational state is the same as the first operational state or the second operational state is different from the first operational state). Causing the first set of one or more devices to operate in a respective manner based on an operational state of the computer system allows the computer system to control the operation of the first set of one or more devices to indicate the present operational state of the computer system, thereby providing improved feedback and performing an operation when a set of conditions has been met without requiring further user input and providing improved feedback.

In some embodiments, the first context corresponds to a first body position of the user (e.g., the user is standing, the user is kneeling, the user is sitting, the user is bending over, the user is moving, the user is not moving). In some embodiments, the second corresponds to a second body position of the user (e.g., the user is standing, the user is kneeling, the user is sitting, the user is bending over, the user is moving, the user is not moving) different from the first body position. Causing the first set of one or more devices to operate in a respective manner based on the body position of the user allows the user to control the operation of the first set of one or more devices without requiring that the computer system display a respective user interface object, thereby performing an operation when a set of conditions has been met without requiring further user input and providing improved feedback.

Note that details of the processes described above with respect to process 1300 (e.g., FIG. 9) are also applicable in an analogous manner to the methods described herein. For example, process 700 optionally includes one or more of the characteristics of the various methods described above with reference to process 1300. For example, the first set of devices of process 1300 can be controlled via the first set of one or more controls or the second set of one or more controls of process 700. For brevity, these details are not repeated.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A method, comprising:
at a computer system that is in communication with a display component:
detecting a change to a coupling status of the computer system; and
in response to detecting the change to the coupling status of the computer system:
in accordance with a determination that a first set of one or more criteria is met, wherein the first set of one or more criteria includes a criterion that is met when a determination is made that the computer system is currently magnetically coupled to a respective area, displaying, via the display component, a first user interface that includes a first set of one or more controls; and
in accordance with a determination that a second set of one or more criteria is met, wherein the second set of one or more criteria includes a criterion that is met when a determination is made that the computer system is not currently magnetically coupled, displaying, via the display component, a second user interface that includes a second set of one or more controls, wherein the second set of one or more controls are different from the first set of one or more controls.

2. The method of claim 1, wherein the first set of one or more criteria includes a criterion that is met when a determination is made that the respective area is associated with a first type of device, the method further comprising:
in response to detecting the change in the coupling status of the computer system and in accordance with a determination that the computer system is currently magnetically coupled to a second respective area, wherein the second respective area is associated with a second type of device that is different from the first type of device, forgoing displaying the first set of one or more controls.

3. The method of claim 1, further comprising:
while displaying the first user interface that includes the first set of one or more controls, displaying, via the display component, a first set of indications corresponding to one or more settings related to the respective area.

4. The method of claim 1, further comprising:
in response to detecting the change to the coupling status of the computer system and in accordance with a determination that the computer system is currently magnetically connected to a third respective area that is different from the respective area, displaying, via the display component, a third set of one or more controls that is different from the first set of one or more controls.

5. The method of claim 1, further comprising:
in response to detecting the change to the coupling status of the computer system, transitioning the display component from a first state to a second state that is different from the first state.

6. The method of claim 1, wherein the first set of one or more controls are local controls that are directed to one or more devices associated with the respective area and not a fourth respective area that is different from the respective area, and wherein the second set of one or more controls are global controls that are directed to one or more devices associated with the respective area and the fourth respective area.

7. The method of claim 1, wherein the first set of one or more controls do not include and the second set of one or more controls includes a control that, when selected, causes output of media to be adjusted.

8. The method of claim 1, wherein the first set of one or more controls includes and the second set of one or more controls do not include a control, that when selected, causes output of a device that impacts temperature of the environment to be adjusted.

9. The method of claim 1, further comprising:
while displaying the second set of one or more controls, detecting an input directed to one control in the second set of one or more controls; and
in response to detecting the input directed to the one control in the second set of one or more controls, displaying, via the display component, an indication that a value has been adjusted.

10. The method of claim 1, further comprising:
while displaying the first set of one or more controls, detecting an input directed to one control in the first set of one or more controls; and
in response to detecting the input directed to the one control in the first set of one or more controls, forgoing displaying, via the display component, an indication that a value has been adjusted.

11. The method of claim 1, further comprising:
while displaying the first set of one or more controls, detecting a set of one or more inputs that includes an input directed to a respective control in the first set of one or more controls; and
in response to detecting the set of one or more inputs, causing output of a device associated with the respective area to change.

12. The method of claim 1, wherein the second set of one or more controls consists of a first number of controls, and wherein the first set of one or more controls consists of a second number of controls that is different from the first number of controls.

13. The method of claim 1, wherein the second set of one or more controls includes a control that is included in the first set of one or more controls.

14. The method of claim 1, wherein the first set of one or more controls includes at least one control that is not included in the second set of one or more controls.

15. The method of claim 1, wherein each control in the first set of one or more controls is different from each control in the second set of one or more controls.

16. A non-transitory computer-readable storage medium storing one or more programs configured to be executed by one or more processors of a computer system that is in communication with a display component, the one or more programs including instructions for:
detecting a change to a coupling status of the computer system; and
in response to detecting the change to the coupling status of the computer system:
in accordance with a determination that a first set of one or more criteria is met, wherein the first set of one or more criteria includes a criterion that is met when a determination is made that the computer system is currently magnetically coupled to a respective area, displaying, via the display component, a first user interface that includes a first set of one or more controls; and
in accordance with a determination that a second set of one or more criteria is met, wherein the second set of one or more criteria includes a criterion that is met when a determination is made that the computer system is not currently magnetically coupled, displaying, via the display component, a second user interface that includes a second set of one or more controls, wherein the second set of one or more controls are different from the first set of one or more controls.

17. A computer system that is in communication with a display component, comprising:
one or more processors; and
memory storing one or more programs configured to be executed by the one or more processors, the one or more programs including instructions for:
detecting a change to a coupling status of the computer system; and
in response to detecting the change to the coupling status of the computer system:
in accordance with a determination that a first set of one or more criteria is met, wherein the first set of one or more criteria includes a criterion that is met when a determination is made that the computer system is currently magnetically coupled to a respective area, displaying, via the display component, a first user interface that includes a first set of one or more controls; and
in accordance with a determination that a second set of one or more criteria is met, wherein the second set of one or more criteria includes a criterion that is met when a determination is made that the computer system is not currently magnetically coupled, displaying, via the display component, a second user interface that includes a second set of one or more controls, wherein the second set of one or more controls are different from the first set of one or more controls.
